(19) United States
(12) Patent Application Publication
(10) Pub. No.: US 2026/0264237 A1
(43) Pub. Date: Sep. 10, 2026

(54) MANIPULATOR AND METHOD FOR CONTROLLING MANIPULATOR

(71) Applicant: SONY GROUP CORPORATION, TOKYO (JP)

(72) Inventor: YASUHIRO MATSUDA, TOKYO (JP)

(21) Appl. No.: 19/166,665

(22) PCT Filed: Mar. 22, 2024
(86) PCT No.: PCT/JP2024/011294

§ 371 Date: Sep. 18, 2025

(30) Foreign Application Priority Data
Mar. 31, 2023 (JP) 2023-059522

(51) Int. Cl. B25J 9/16; B25J 13/08

(52) U.S. Cl. CPC B25J 9/1664; B25J 13/085; B25J 13/089

(57) ABSTRACT

To enable execution of a task with a high success rate without detailed information. A manipulator is a manipulator including a setting unit configured to set a movement direction in which at least one part of the manipulator is caused to move and a passive direction in which the part has passivity; and a movement control unit configured to control a movement of the part based on the set movement direction and passive direction.

### FIELD

The present invention relates to a manipulator and a method for controlling a manipulator.

### BACKGROUND

In a case where a manipulator such as a robot coexists with a human in a living environment of the human, it has been attempted to cause the manipulator to perform a work that has been manually performed.

However, there is a task that is difficult to perform by the conventional control method in an environment where a position, a posture, a shape, and dynamic characteristics of an object that is a work target of a task by a manipulator are unknown. In particular, in a manipulation task under environmental contact executed by a manipulator in contact with an object, such as application of a force to a surrounding object by the manipulator, an error (deviation) occurs in movement of the manipulator depending on the dynamic characteristics of the object and a movement direction of the manipulator. Therefore, in the manipulation task under the environmental contact, the movement of the manipulator tends to be unstable. Therefore, there is a technique for preventing an error from occurring in a movement of a manipulator under an environment where the manipulator comes into contact with an object (see, for example, Patent Literatures 1 to 9).

### CITATION LIST

### Patent Literature

Patent Literature 1: JP 2017-154193 A
Patent Literature 2: JP 2010-221320 A
Patent Literature 3: JP 2022-50147 A
Patent Literature 4: JP 2015-85497 A
Patent Literature 5: JP 2022-18716 A
Patent Literature 6: JP 2019-111352 A
Patent Literature 7: JP 2010-149275 A
Patent Literature 8: JP 2000-42962 A
Patent Literature 9: WO 2020/017370 A

### SUMMARY

### Technical Problem

However, the conventional technique as described above may not be able to execute a task with a high success rate without detailed information.

Hereinafter, an example of a problem of the conventional technique will be described with reference to FIG. 24. FIG. 24 is a diagram for describing an example of a problem of the conventional technique. For example, as illustrated in diagrams of recognition, estimation, and modeling of an environment in FIG. 24, in a case where there is no prior knowledge of a shape, dynamic characteristics, and the like of an object and a manipulator is caused to move in a three-dimensional space, the manipulator needs to recognize and estimate an environment model such as a geometric model, a physical model, and a constraint model.

On the other hand, as illustrated in a diagram of an environment recognition error and a movement error in FIG. 24, since these environment models also include an error, the error may act as a disturbance for the movement of the manipulator. In addition, when a movement of a part of the manipulator is controlled, all command values of a position and a posture of a distal end portion of a hand portion of the manipulator in a space (Cartesian space) represented by a Cartesian coordinate system need to be instructed. For this purpose, a detailed environment model and a plan (for example, a radius of rotation of a door or the like) are required. In addition, prior knowledge such as excessive recognition, estimation, and dynamic characteristics of the environment model rather acts as a disturbance, and a movement error of the manipulator may lead to instability of the movement of the manipulator, a task failure, and an error state.

One aspect of the present disclosure enables execution of a task with a high success rate without detailed information.

### Solution to Problem

A manipulator according to one aspect of the present disclosure includes a setting unit configured to set a movement direction in which at least one part of the manipulator is caused to move and a passive direction in which the part has passivity, and a control unit configured to control a movement of the part based on the movement direction and the passive direction set by the setting unit.

A method for controlling a manipulator according to one aspect of the present disclosure is a method for controlling a manipulator executed by a manipulator, the method includes, a setting step of setting a movement direction in which at least one part of the manipulator is caused to move and a passive direction in which the part has passivity, and a control step of controlling a movement of the part based on the movement direction and the passive direction set by the setting step.

### BRIEF DESCRIPTION OF DRAWINGS

FIG. 1 is a diagram illustrating an example of a schematic configuration of a robot according to a first embodiment.

FIG. 2 is a diagram illustrating an example of a configuration of a head portion in the first embodiment.

FIG. 3 is a diagram illustrating an example of a configuration of a manipulator unit in the first embodiment.

FIG. 4 is a diagram illustrating an example of a configuration of a control unit in the first embodiment.

FIG. 5 is a diagram illustrating an example of an operation of the robot according to the first embodiment.

FIG. 6 is a diagram illustrating an example of an operation of the robot according to the first embodiment.

FIG. 7 is a diagram illustrating an example of an operation of the robot according to the first embodiment.

FIG. 8 is a diagram illustrating an example of a circuit of the control unit in the first embodiment.

FIG. 9 is a diagram illustrating an example of a circuit of the control unit in the first embodiment.

FIG. 10 is a diagram illustrating an example of a relationship between a deviation and a rigidity.

FIG. 11 is a diagram illustrating an example of a circuit of the control unit in the first embodiment.

FIG. 12 is a diagram illustrating an example of a Gaussian mixture model.

FIG. 13 is a diagram illustrating an example of a configuration of a mobile body unit in the first embodiment.

FIG. 14 is a diagram illustrating an example of a configuration of a storage unit in the first embodiment.

FIG. 15 is a diagram illustrating an example of a flow of processing by the robot according to the first embodiment.

FIG. 16 is a diagram illustrating an example of a schematic configuration of a robot according to a second embodiment.

FIG. 17 is a diagram illustrating an example of a configuration of a manipulator unit in the second 5 embodiment.

FIG. 18 is a diagram illustrating an example of a configuration of a control unit in the second embodiment.

FIG. 19 is a diagram illustrating an example of a configuration of a storage unit in the second embodiment. 10 FIG. 20 is a diagram illustrating an example of a schematic configuration of a robot according to a third embodiment.

FIG. 21 is a diagram illustrating an example of a configuration of a control unit in the third embodiment.

FIG. 22 is a diagram for describing an example of setting by the robot according to the third embodiment.

FIG. 23 is a block diagram illustrating an example of a hardware configuration of an apparatus.

FIG. 24 is a diagram for describing an example of a problem of a conventional technique.

### DESCRIPTION OF EMBODIMENTS

Hereinafter, embodiments of the present disclosure will be described in detail with reference to the drawings. In the following embodiments, the same elements are denoted by the same reference numerals, and redundant description may be omitted.

The present disclosure will be described according to the following order of items.
0. Introduction
1. First Embodiment
2. Second Embodiment
3. Third Embodiment
4. Example of Hardware Configuration
5. Example of Effects

### 0. Introduction

As described above, in conventional techniques such as Patent Literatures 1 to 9, there is a case where a task cannot be executed with a high success rate without detailed information. For example, in a case where there is no prior knowledge of a shape, dynamic characteristics, and the like of an object and a manipulator is caused to move in a three-dimensional space, an environment model recognized and estimated by the manipulator includes an error, and thus the error may act as a disturbance for the movement of the manipulator. In addition, when a movement of a part of the manipulator is controlled, all command values of a position and a posture of a distal end portion of a hand portion of the manipulator in a space (Cartesian space) represented by a Cartesian coordinate system need to be instructed. For this purpose, a detailed environment model and a plan (for example, a radius of rotation of a door or the like) are required. In addition, prior knowledge such as excessive recognition, estimation, and dynamic characteristics of the environment model rather acts as a disturbance, and a movement error of the manipulator may lead to instability of the movement of the manipulator, a task failure, and an error state.

According to a technique of the present disclosure, it is possible to execute a task with a high success rate without detailed information. A specific technique will be described in the following embodiments.

### 1. First Embodiment

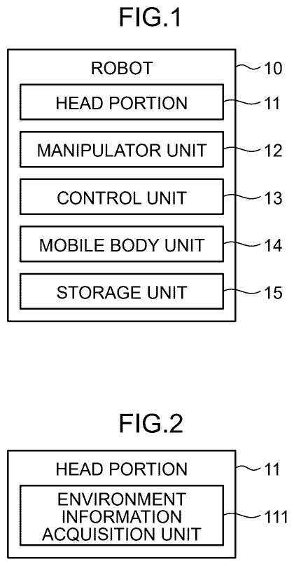

FIG. 1 is a diagram illustrating an example of a schematic configuration of a robot according to a first embodiment. A robot (manipulator) 10 sets a movement direction and a passive direction, and controls a movement of at least one part of the manipulator based on the set movement direction and passive direction.

The movement direction refers to a direction in which at least one part of the robot 10 is caused to move. For example, the movement direction refers to a direction along a movement constraint axis that constrains the movement of the part of the robot 10 so as to actively follow at least one of three axes or a trajectory along an axis opposite to the at least one of the three axes in a Cartesian space. The movement direction may include a translation direction in which the part is caused to execute a translational movement, a rotation direction along a rotation axis in which the part is caused to execute a rotational movement, or a direction in which the movement direction is not set, in which the direction in which the part is caused to move is “none”.

The passive direction refers to a direction in which at least one part of the robot 10 has passivity. For example, the passive direction refers to a direction in which, in a case where the part is brought into contact with an object, a movement of causing the part to receive the object, such as a movement of causing the part to rotationally move in a three-dimensional direction (3D direction) is performed so that the direction of the part becomes the same direction as the direction before being brought into contact with the object. The passive direction may include a translation direction, a rotation direction, or a direction in which the passive direction is not set, in which a direction in which the part has passivity is “none”.

Examples of the robot 10 include a humanoid robot and the like. Hereinafter, an example in which the robot 10 is a humanoid robot will be mainly described, but the robot 10 is not limited to a humanoid robot, and may be, for example, a robot arm or the like corresponding to at least one part of a humanoid robot. In the example illustrated in FIG. 1, the robot 10 includes a head portion 11, a manipulator unit 12, a control unit 13, a mobile body unit 14, and a storage unit 15. In the example illustrated in FIG. 1, the control unit 13 is included inside the robot 10, but may be present outside the robot 10.

The head portion 11 is a part corresponding to a head portion of the robot 10 that is a humanoid robot. Hereinafter, a configuration of the head portion 11 will be described with reference to FIG. 2. FIG. 2 is a diagram illustrating an example of a configuration of a head portion in the first embodiment. In the example illustrated in FIG. 2, the head portion 11 includes an environment information acquisition unit (acquisition unit) 111. The head portion 11 may further include a member corresponding to at least one of a rotation angle detection unit 121111 and a joint drive unit 1212 to be described later.

The environment information acquisition unit 111 acquires environment information. The environment information refers to information regarding an environment around the robot 10. Examples of the environment information include imaging information by a camera and the like. For example, the environment information acquisition unit 111 acquires environment information including an object. As an example, the environment information acquisition unit 111 acquires environment information including a door. The environment information acquisition unit 111 is not particularly limited as long as it is a sensor that detects and recognizes environment information, and examples thereof include a red-green-blue color model (RGB) camera, a depth camera, and the like.

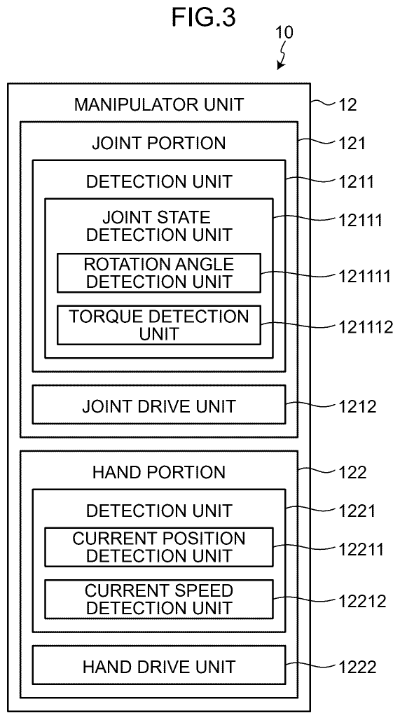

The description returns to FIG. 1. The manipulator unit 12 includes a part whose movement is controlled by the control unit 13. Hereinafter, a configuration of the manipulator unit 12 will be described with reference to FIG. 3. FIG. 3 is a diagram illustrating an example of a configuration of a manipulator unit in the first embodiment. In the example illustrated in FIG. 3, the manipulator unit 12 includes a joint portion 121 and a hand portion 122.

The joint portion 121 is a part corresponding to a joint of the manipulator unit 12. The joint portion 121 is, for example, an elastic joint portion 121 or the like provided around the part, and examples of such a joint portion 121 include a joint portion of an elbow portion located in the vicinity of the hand portion 122 and the like. The joint portion 121 includes a detection unit 1211 and the joint drive unit 1212.

The detection unit 1211 detects information regarding the joint portion 121. In the example illustrated in FIG. 3, the detection unit 1211 includes a joint state detection unit 12111.

The joint state detection unit 12111 detects a state of the joint portion 121. In the example illustrated in FIG. 3, the joint state detection unit 12111 includes a rotation angle detection unit 121111 and a torque detection unit 121112. The rotation angle detection unit 121111 detects a rotation angle of the joint portion 121. Examples of the rotation angle detection unit 121111 include an encoder and the like. The torque detection unit 12112 detects a torque of the joint portion 121. Examples of the torque detection unit 12112 include a torque sensor and the like.

The joint drive unit 1212 drives the joint portion 121. The joint drive unit 1212 is not particularly limited as long as it drives the joint portion 121, and examples thereof include a motor and the like.

The hand portion 122 is a part corresponding to a hand of the manipulator unit 12. In the example illustrated in FIG. 3, the hand portion 122 is also a part whose movement is controlled by the control unit 13. In the example illustrated in FIG. 3, the hand portion 122 includes a detection unit 1221 and a hand drive unit 1222.

The detection unit 1221 detects information regarding the hand portion 122. In the example illustrated in FIG. 3, the detection unit 1221 includes a current position detection unit 12211 and a current speed detection unit 12212.

The current position detection unit 12211 detects a current position of the part. In the example illustrated in FIG. 3, the current position detection unit 12211 detects a current position of the hand portion 122. The current speed detection unit 12212 detects a current speed of the part. In the example illustrated in FIG. 3, the current speed detection unit 12212 detects a current speed of the hand portion 122.

The hand drive unit 1222 drives the hand portion 122. The hand drive unit 1222 is not particularly limited as long as it drives the hand portion 122, and examples thereof include a motor and the like.

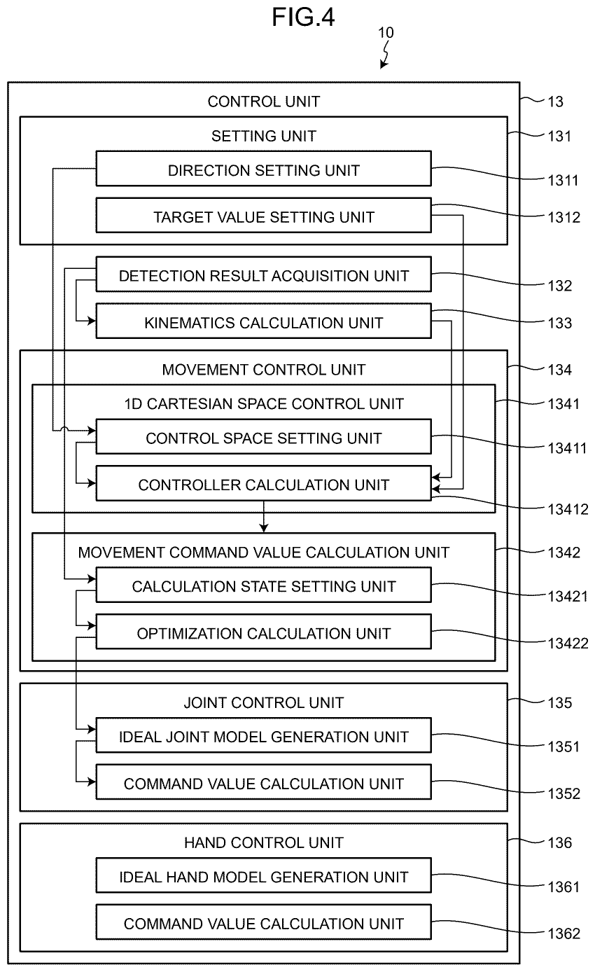

The description returns to FIG. 1. The control unit 13 controls the entire robot 10. The control unit 13 includes, for example, one or more processors having a program defining each processing procedure and an internal memory storing control data, and the processor executes each processing using the program or the internal memory. Examples of the control unit 13 include an electronic circuit such as a central processing unit (CPU), a micro processing unit (MPU), and a graphics processing unit (GPU), and an integrated circuit such as an application specific integrated circuit (ASIC) and a field programmable gate array (FPGA). A configuration of the control unit 13 will be described below with reference to FIG. 4. FIG. 4 is a diagram illustrating an example of a configuration of a control unit. In the example illustrated in FIG. 4, the control unit 13 includes a setting unit 131, a detection result acquisition unit 132, a kinematics calculation unit 133, a movement control unit 134, a joint control unit 135, and a hand control unit 136.

The setting unit 131 executes various settings of the robot 10. In the example illustrated in FIG. 4, the setting unit 131 includes a direction setting unit (setting unit) 1311 and a target value setting unit (setting unit) 1312.

The direction setting unit 1311 sets a movement direction in which at least one part of the robot 10 is caused to move and a passive direction in which the part has passivity. A method for setting these directions by the direction setting unit 1311 is not particularly limited, and may be, for example, a setting method based on setting information set by a user, or a setting method based on information acquired, recognized, and searched by the robot 10 itself. The direction setting unit 1311 may set a plurality of movement directions and passive directions for each part. In addition, the direction setting unit 1311 may set a movement axis along the movement direction and a passive axis along the passive direction instead of the movement direction and the passive direction as long as the same effect can be obtained.

When setting the movement direction and the passive direction based on the information acquired, recognized, and searched by the robot 10 itself, the direction setting unit 1311 may set the movement direction and the passive direction based on the environment information acquired by the environment information acquisition unit 111. When the environment information acquisition unit 111 acquires environment information including an object, the direction setting unit 1311 may set a movement direction and a passive direction based on the object included in the environment information acquired by the environment information acquisition unit 111. When the environment information acquisition unit 111 acquires environment information including a door, the direction setting unit 1311 may set a movement direction and a passive direction based on a type of the door included in the environment information acquired by the environment information acquisition unit 111. For example, the direction setting unit 1311 sets a movement direction and a passive direction to different directions between a case where the type of the door is a sliding door and a case where the type of the door is a hinged door.

The direction setting unit 1311 may set the movement direction to a translation direction in which the part is caused to execute a translational movement, and set the passive direction to a rotation direction along a rotation axis in which the part is caused to execute a rotational movement. For example, the direction setting unit 1311 sets the movement direction to a translation direction in which the hand portion 122 is caused to execute a translational movement, and sets the passive direction to a rotation direction along a rotation axis in which the hand portion 122 is caused to execute a rotational movement.

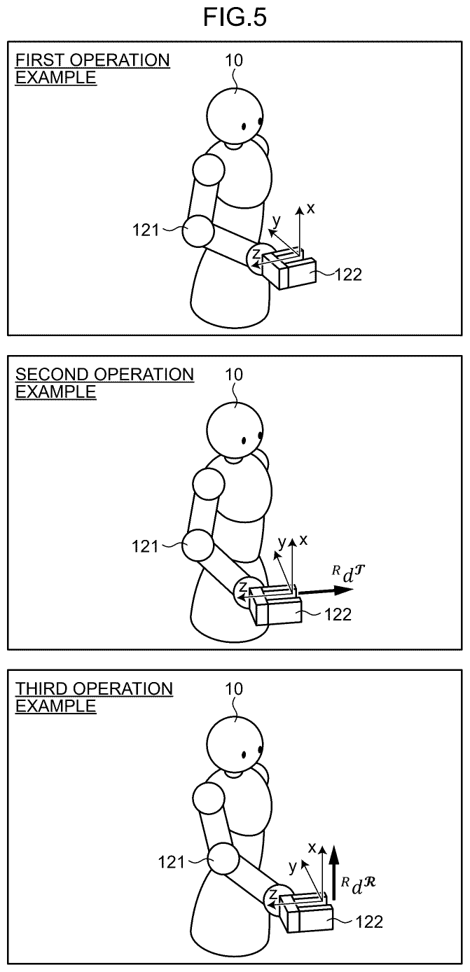

Hereinafter, an example of setting of the direction by the direction setting unit 1311 will be described with reference to FIGS. 5 to 7. FIGS. 5 to 7 are diagrams illustrating an example of an operation of the robot according to the first embodiment.

In the diagram illustrated in a first operation example of FIG. 5, the direction setting unit 1311 does not set a movement direction for the hand portion 122 by setting a movement direction in which the hand portion 122 of the robot 10 is caused to actively move to “none”. The direction setting unit 1311 sets a passive direction in which the hand portion 122 has passivity to a two-dimensional direction (2D direction) such as a y-axis direction, a −y-axis direction, a z-axis direction, and a −z-axis direction. The direction setting unit 1311 sets the passive direction to a rotation direction along a rotation axis in which the hand portion 122 is caused to execute a rotational movement. That is, the direction setting unit 1311 sets the passive direction so as to cause the hand portion 122 to execute the rotational movement in the 2D direction in a case where the hand portion 122 is brought into contact with an object. As a result, the hand portion 122 rotationally moves in the 2D direction when brought into contact with the object, and the direction of the hand portion 122 becomes the same direction as the direction before being brought into contact with the object as if the direction is maintained.

In the diagram illustrated in a second operation example of FIG. 5, the direction setting unit 1311 sets the movement direction of the hand portion 122 to a one-dimensional direction (1D direction), which is a −z-axis direction, and sets the movement direction to a translation direction. That is, the direction setting unit 1311 constrains the movement of the hand portion 122 so that the hand portion 122 follows the trajectory along the −z-axis direction. The direction setting unit 1311 sets the passive direction of the hand portion 122 to the 2D direction such as the y-axis direction, the −y-axis direction, the z-axis direction, and the −z-axis direction, and sets the passive direction to a rotation direction. As a result, the hand portion 122 rotationally moves in the 2D direction when brought into contact with the object, and the direction of the hand portion 122 becomes the same direction as the direction before being brought into contact with the object as if the direction is maintained.

In the diagram illustrated in a third operation example of FIG. 5, the direction setting unit 1311 sets the movement direction to “none”. For this reason, the hand portion 122 does not actively move, and the position of the hand portion 122 is maintained (fixed) unless the hand portion 122 passively moves due to the contact with the object or other reasons. In addition, the direction setting unit 1311 sets the passive direction to the 1D direction, which is an x-axis direction, and sets the passive direction to a rotation direction. That is, the direction setting unit 1311 sets the rotation direction so that the hand portion 122 has passivity about the set axis in the x-axis direction and executes a rotational movement about the axis in the x-axis direction when the hand portion 122 comes into contact with the object.

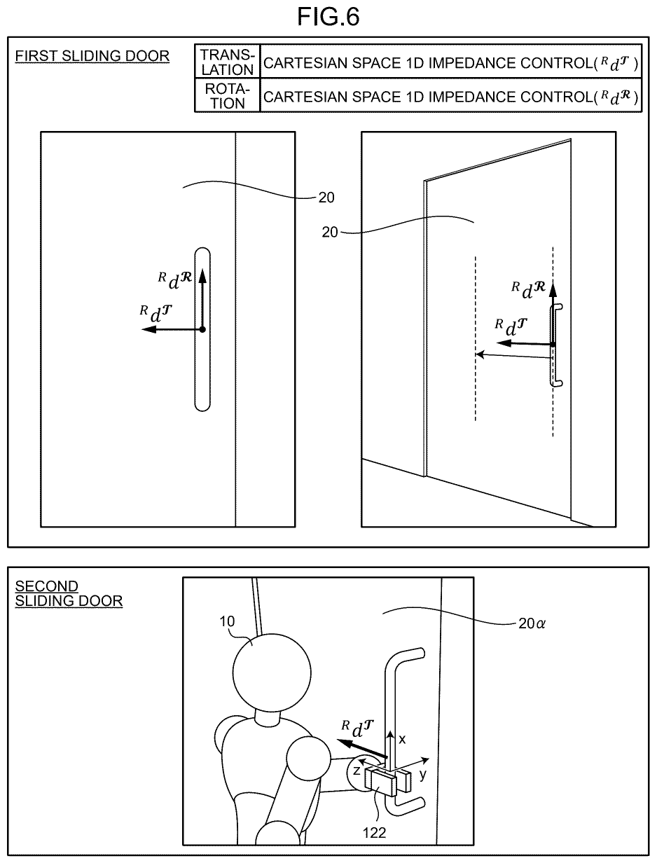

In the diagram of a first sliding door in FIG. 6, the direction setting unit 1311 sets a movement direction for causing the hand portion 122 of the robot 10 to open a door 20 to a 1D direction in the Cartesian space, which is an ^{R}d^{J} direction, and sets the movement direction to a translation direction. In addition, the direction setting unit 1311 sets a passive direction to a 1D direction, which is an ^{R}d^{R} direction, and sets the passive direction to a rotation direction.

In the diagram of a second sliding door in FIG. 6, the direction setting unit 1311 sets a movement direction for causing the hand portion 122 of the robot 10 to open a door 20α to the 1D direction in the Cartesian space, which is an ^{R}d^{J} direction, and sets the movement direction to a translation direction. The direction setting unit 1311 sets the passive direction to “none”.

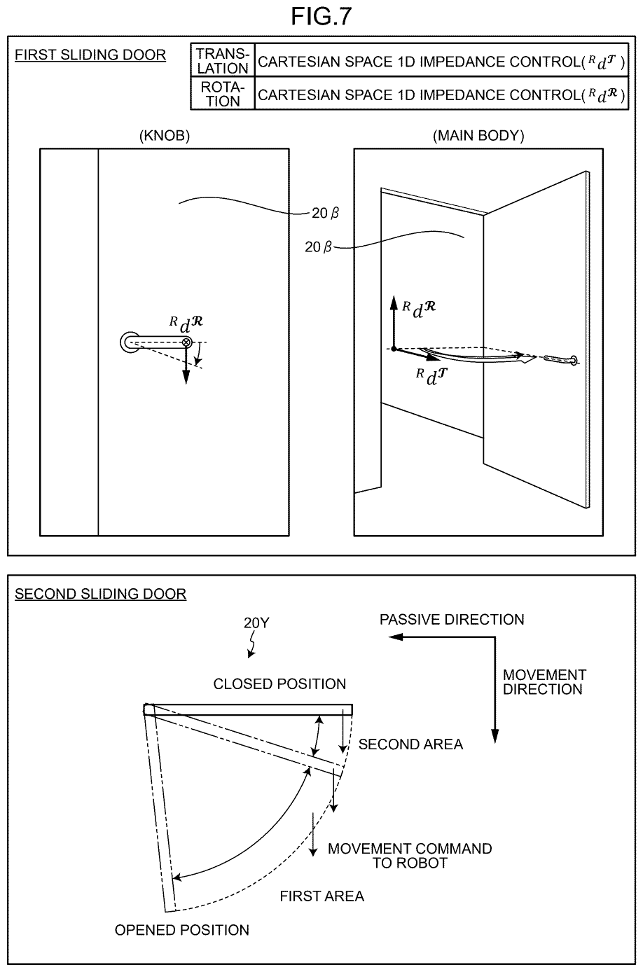

In the diagram of a first hinged door in FIG. 7, the direction setting unit 1311 sets a movement direction for causing the hand portion 122 of the robot 10 to open a knob of a door 20β to the 1D direction in the Cartesian space, which is the ^{R}d^{J} direction different between the knob and a main body of the door 20β. The direction setting unit 1311 sets the movement direction to a translation direction. In addition, the direction setting unit 1311 sets a passive direction to the 1D direction in the Cartesian space, which is the ^{R}d^{R} direction different between the knob and the main body of the door 20β, and sets the passive direction to a rotation direction.

In the diagram of a second sliding door in FIG. 7, the direction setting unit 1311 sets a movement direction for causing the hand portion 122 of the robot 10 to open a knob of a door 20γ to a vertical downward direction, and sets the movement direction to a translation direction. In addition, the direction setting unit 1311 sets a passive direction to a horizontal left direction when viewed from the side facing the diagram of the second sliding door of FIG. 7, and sets the passive direction to a rotation direction.

The description returns to FIG. 4. The target value setting unit 1312 sets a target value related to the movement of the part. For example, the target value setting unit 1312 sets at least one of a target position and a target speed of the part. As an example, the target value setting unit 1312 sets a target position and a target speed of a distal end portion of the hand portion 122. In the above-described example, the target value setting unit 1312 sets the target speed of the part, but may set a target acceleration instead of or in addition to the target speed. Furthermore, the target value setting unit 1312 may further set a target torque of the joint portion 121.

The detection result acquisition unit 132 acquires detection result detected by the detection unit 1211 in the joint portion 121 and the detection unit 1221 in the hand portion 122 of the manipulator unit 12. For example, the detection result acquisition unit 132 acquires a joint state of the joint portion 121 detected by the joint state detection unit 12111 of the detection unit 1211. More specifically, the detection result acquisition unit 132 acquires, as the joint state of the joint portion 121, a rotation angle of the joint portion 121 detected by the rotation angle detection unit 121111 of the joint state detection unit 12111 and the torque of the joint portion 121 detected by the torque detection unit 121112 of the joint state detection unit 12111. The detection result acquisition unit 132 also acquires a current position of the hand portion 122 detected by the current position detection unit 12211 of the detection unit 1221 and a current speed of the hand portion 122 detected by the current speed detection unit 12212.

The kinematics calculation unit 133 executes calculation based on the detection result acquired by the detection result acquisition unit 132. For example, the kinematics calculation unit 133 executes calculation for conforming to the law applied to calculation by a controller calculation unit 13412 to be described later on the detection result.

The movement control unit 134 controls the movement of the part based on the movement direction and the passive direction set by the direction setting unit 1311 of the setting unit 131. For example, the movement control unit 134 moves the part in each of the set movement direction and the set passive direction. Before describing a configuration of the movement control unit 134, an outline of the movement control unit 134 will be described below.

The movement control unit 134 may cause the part to execute a translational movement and a rotational movement based on the movement direction and the passive direction set by the direction setting unit 1311. For example, when the movement direction is set to a translation direction, the movement control unit 134 causes the part to execute a translational movement toward the set movement direction, and when the passive direction is set to a rotation direction, the movement control unit 134 causes the part to execute a rotational movement toward the set passive direction. Hereinafter, an example of the above-described outline will be described with reference to FIGS. 5 to 7.

In the diagram of the first operation example of FIG. 5, since the movement direction is set to “none” by the direction setting unit 1311, the movement control unit 134 does not cause the hand portion 122 to execute an active movement. In addition, since the passive direction is set to the 2D direction such as the y-axis direction, the −y-axis direction, the z-axis direction, and the −z-axis direction by the direction setting unit 1311 and the passive direction is set to the rotation direction, the movement control unit 134 causes the hand portion 122 to have passivity in the 2D direction and execute the rotational movement in the 2D direction when the hand portion 122 is brought into contact with an object.

In the diagram of the second operation example of FIG. 5, since the movement direction is set to the 1D direction, which is the −z-axis direction, and the movement direction is set to the translation direction by the direction setting unit 1311, the movement control unit 134 causes the hand portion 122 to execute the translational movement in the −z-axis direction. In addition, since the passive direction is set to the 2D direction such as the y-axis direction, the −y-axis direction, the z-axis direction, and the −z-axis direction by the direction setting unit 1311 and the passive direction is set to the rotation direction, the movement control unit 134 causes the hand portion 122 to have passivity in the 2D direction and execute the rotational movement in the 2D direction when the hand portion 122 is brought into contact with an object.

In the diagram illustrated in the third operation example of FIG. 5, the movement direction is set to “none” by the direction setting unit 1311. In this case, the movement control unit 134 does not cause the hand portion 122 to execute an active movement. Further, the passive direction is set to the 1D direction, which is the x-axis direction, and the rotation direction is set to the passive direction by the direction setting unit 1311. In this case, the movement control unit 134 causes the hand portion 122 to have passivity in the x-axis direction, and causes the hand portion 122 to execute a rotational movement about an axis in the x-axis direction when the hand portion 122 is brought into contact with an object.

In the diagram of the first sliding door of FIG. 6, the movement direction is set to the 1D direction, which is the ^{R}d^{J} direction, and the movement direction is set to the translation direction by the direction setting unit 1311. Therefore, the movement control unit 134 causes the hand portion 122 to execute a translational movement of opening the door 20 in the ^{R}d^{J} direction. In addition, the passive direction is set to the 1D direction, which is the ^{R}d^{R} direction, and the passive direction is set to the rotation direction by the direction setting unit 1311. Therefore, the movement control unit 134 causes the hand portion 122 to have passivity in the ^{R}d^{R} direction, and causes the hand portion 122 to execute a rotational movement with the ^{R}d^{R} direction as a rotation axis when the hand portion 122 is brought into contact with the door 20.

In the diagram of the second sliding door of FIG. 6, the movement direction is set to the 1D direction, which is the ^{R}d^{J} direction, and the movement direction is set to the translation direction by the direction setting unit 1311. Therefore, the movement control unit 134 causes the hand portion 122 to execute a translational movement of opening the door 200 in the ^{R}d^{J} direction. The passive direction is set to “none” by the direction setting unit 1311. Therefore, the movement control unit 134 does not cause the hand portion 122 to have passivity.

In the diagram of the first hinged door of FIG. 7, the movement direction is set to the 1D direction, which is the ^{R}d^{J} direction different between the knob and the main body of the door 20β, and the movement direction is set to the translation direction by the direction setting unit 1311. In addition, the passive direction is set to the 1D direction, which is the ^{R}d^{R} direction different between the knob and the main body of the door 20β, and the passive direction is set to the rotation direction by the direction setting unit 1311. Therefore, the movement control unit 134 causes the hand portion 122 to execute a translational movement of opening the door 20β in the ^{R}d^{J} direction different between the knob and the main body of the door 20β. In addition, in a case where the hand portion 122 is brought into contact with the door 20β, the movement control unit 134 causes the hand portion 122 to execute a rotational movement with the ^{R}d^{R} direction different between the knob and the main body of the door 20β as a rotation axis.

In the diagram of the second sliding door of FIG. 7, the movement direction is set to the vertical downward direction and the movement direction is set to the translation direction by the direction setting unit 1311. In addition, the passive direction is set to the horizontal left direction when viewed from the side facing the diagram of the second sliding door of FIG. 7, and the passive direction is set to the rotation direction by the direction setting unit 1311. Therefore, the movement control unit 134 causes the hand portion 122 to execute a translational movement of opening the knob of the door 20γ in the vertical downward direction. When the hand portion 122 is brought into contact with the door 20γ, the movement control unit 134 causes the hand portion 122 to execute a rotational movement with the horizontal left direction as a rotation axis.

The description returns to FIG. 4. The movement control unit 134 may cause the part to execute a translational movement from the current position detected by the current position detection unit 12211 to the target position set by the target value setting unit 1312 in the setting unit 131. For example, the movement control unit 134 causes the hand portion 122 to execute a translational movement from the current position of the distal end portion of the hand portion 122 to the target position. The movement control unit 134 may cause the part to execute a translational movement so that the current speed detected by the current speed detection unit 12212 becomes the target speed set by the target value setting unit 1312. For example, the movement control unit 134 causes the hand portion 122 to execute a translational movement so that the current speed of the distal end portion of the hand portion 122 becomes the target speed.

The movement control unit 134 may cause the joint portion 121 to execute a movement so that the torque of the joint portion 121 detected by the torque detection unit 121112 becomes the target torque set by the target value setting unit 1312. For example, the movement control unit 134 causes the joint portion 121 to execute a movement according to the movement of the part such as the hand portion 122 so that the detected torque of the joint portion 121 becomes the target torque.

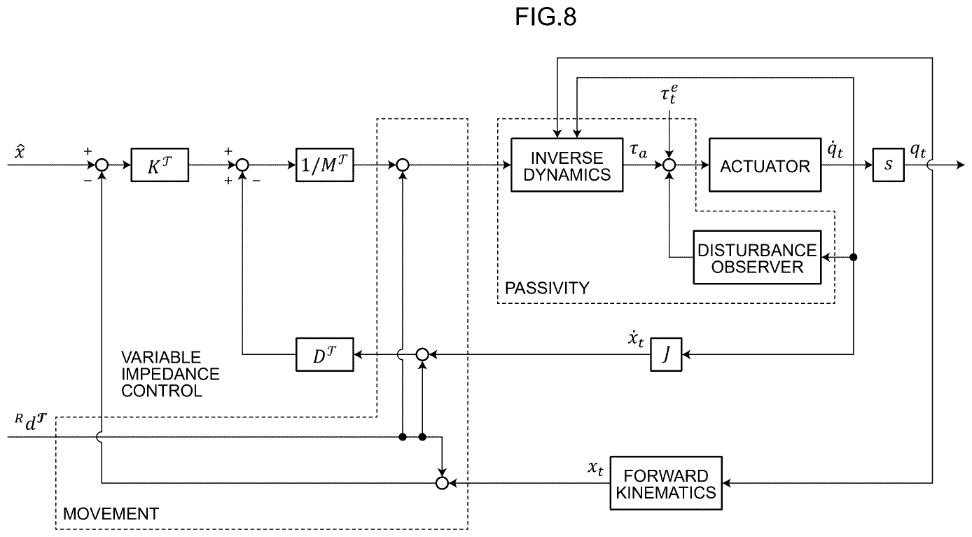

Hereinafter, an example of the above-described outline in a case where the movement control unit 134 (in particular, a 1D Cartesian space control unit 1341 described later and the like in the movement control unit 134) is applied as an impedance controller will be described with reference to FIG. 8. FIG. 8 is a diagram illustrating an example of a circuit of a control unit in the first embodiment. Hereinafter, a case where the movement control unit 134 is applied to an impedance controller will be described, but the movement control unit 134 can also be applied to a proportional-integral-differential (PID) controller, a non-linear controller, and the like in addition to the impedance controller.

In the example illustrated in FIG. 8, the movement control unit 134 controls a driving force of a drive unit (actuator) of the part so that an impedance control law (impedance adaptation strategy) represented by the following Formula (1), which is one of spring-mass-damper system relational expressions, is maintained.

$${M}^{𝒯} {\ddot{x}}_{t} = {K}_{t}^{𝒯} ( \hat{x} - {x}_{t} ) - {D}_{t}^{𝒯} {\dot{x}}_{t} + {f}_{t}^{e} \qquad ( 1 )$$

$$Where ,$$

$$\hat{x} : Target position$$

$${x}_{t} : Current position$$

$${\dot{x}}_{t} : Current speed$$

$${\ddot{x}}_{t} : Target acceleration$$

$$e : Deviation$$

$${K}_{t}^{𝒯} : Rigidity \qquad {K}_{t}^{𝒯} = {k}_{0} ( const )$$

$${D}_{t}^{𝒯} : Viscosity \qquad {D}_{t}^{𝒯} = {d}_{0} ( const )$$

$${M}^{𝒯} : Inertia \qquad {M}^{𝒯} = {m}_{0} ( const )$$

For example, the movement control unit 134 controls a driving force of the hand drive unit 1222 in the hand portion 122 so as to satisfy Formula (1) described above. In addition, the movement control unit 134 controls a driving force of the joint drive unit 1212 of the joint portion 121 so that the above-described Formula (1) is satisfied. As an example, the movement control unit 134 causes the hand portion 122 to execute a translational movement from the detected current position of the distal end portion of the hand portion 122 to the set target position while satisfying the above Formula (1). Furthermore, the movement control unit 134 causes the joint portion 121 to execute a movement according to the movement of the part such as the hand portion 122 so that the detected torque of the joint portion 121 becomes the set a target torque while satisfying the following Formula (1).

The description returns to FIG. 4. The movement control unit 134 may control the movement of the part further based on the state of the joint portion 121 detected by the joint state detection unit 12111. For example, the movement control unit 134 controls the movement of the hand portion 122 further based on the detected state of the joint portion 121. The movement control unit 134 may control the movement of the part further based on the torque of the joint portion 121 detected by the torque detection unit 121112. For example, the movement control unit 134 controls the movement of the hand portion 122 further based on the detected torque of the joint portion 121.

The movement control unit 134 may control passivity of the part based on at least one of a position and a direction of the part. For example, the movement control unit 134 controls passivity of the distal end portion of the hand portion 122 in the movement direction to be lower than passivity of the distal end portion of the hand portion 122 in the passive direction. That is, the movement control unit 134 controls a rigidity of the distal end portion of the hand portion 122 in the movement direction to be higher than a rigidity of the hand portion 122 in the passive direction.

The movement control unit 134 may control the passivity of the hand portion 122 based on a difference between the target position of the distal end portion of the hand portion 122 and the current position of the distal end portion of the hand portion 122. For example, the movement control unit 134 controls the passivity of the hand portion 122 so as to reduce the difference between the target position and the current position of the distal end portion of the hand portion 122. Furthermore, the movement control unit 134 may control the passivity of the hand portion 122 by using a first learning model (learning model) 151. For example, the movement control unit 134 uses the first learning model 151 to control the passivity of the hand portion 122 so as to reduce the difference. In the first learning model 151, when the difference between the target position and the current position of the distal end portion of the hand portion 122 is input, the passivity of the hand portion 122 is output. Details of the first learning model 151 will be described later.

The movement control unit 134 may further control the passivity of the part based on the torque of the joint portion 121 detected by the torque detection unit 121112. The movement control unit 134 may further control the passivity of the part based on the detected torque of the joint portion 121. The movement control unit 134 may control the passivity of the part based on a difference between the target torque of the joint portion 121 set by the target value setting unit 1312 and the torque of the joint portion 121 detected by the torque detection unit 121112. For example, the movement control unit 134 controls the passivity of the hand portion 122 so as to reduce the difference between the set target torque of the joint portion 121 and the detected torque of the joint portion 121. Furthermore, the movement control unit 134 may control the passivity of the part by using a second learning model 152. For example, the movement control unit 134 uses the second learning model 152 to control the passivity of the hand portion 122 so as to reduce the difference. In the second learning model 152, when the difference between the target torque of the joint portion 121 set by the target value setting unit 1312 and the torque of the joint portion 121 detected by the torque detection unit 121112 is input, the passivity of the part is output. Details of the second learning model 152 will be described later.

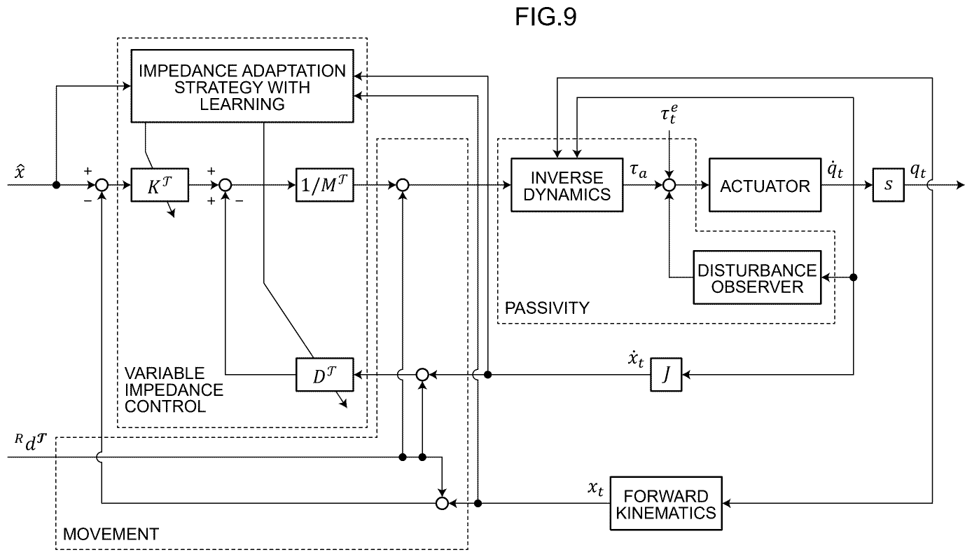

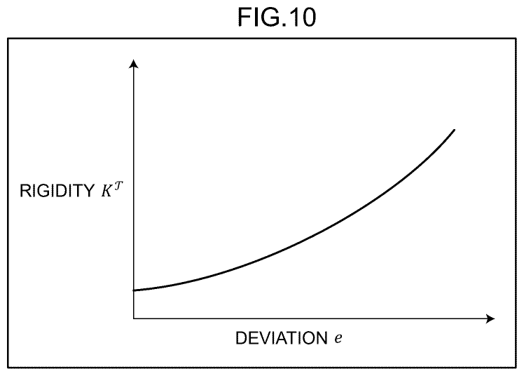

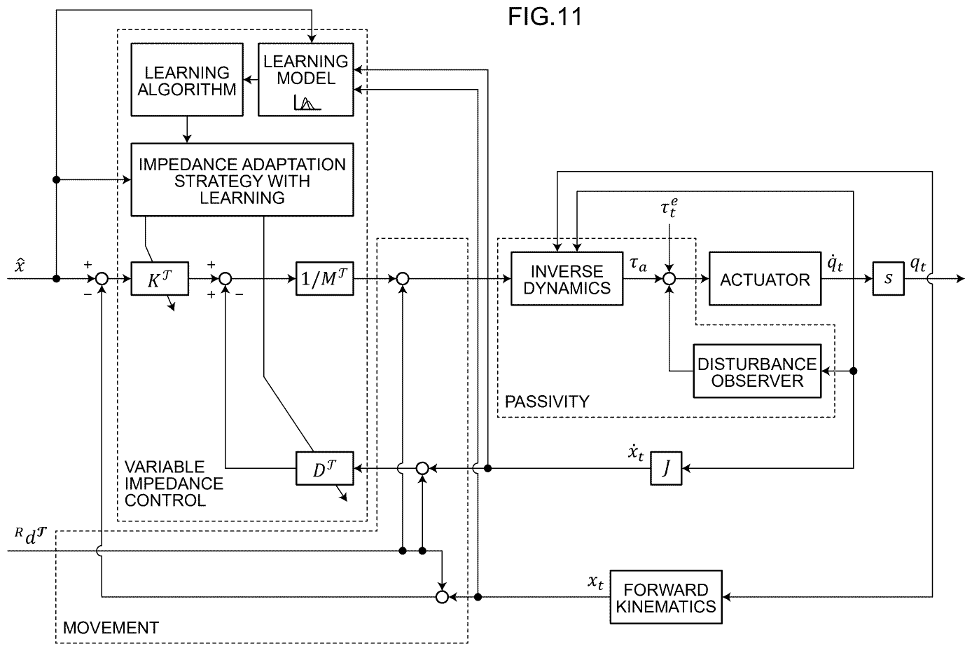

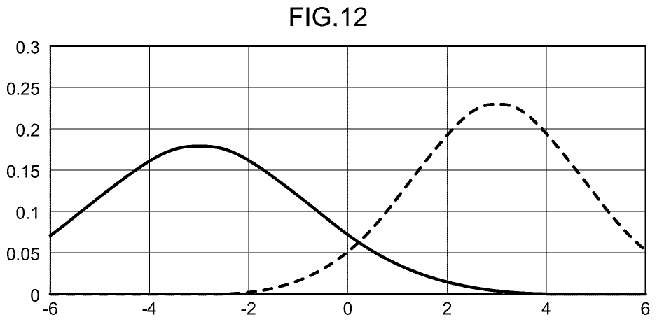

Hereinafter, an example of the above-described outline will be described with reference to FIGS. 9 to 12. FIG. 9 is a diagram illustrating an example of a circuit of a control unit in the first embodiment. FIG. 10 is a diagram illustrating an example of a relationship between a deviation and a rigidity. FIG. 11 is a diagram illustrating an example of a circuit of a control unit in the first embodiment. FIG. 12 is a diagram illustrating an example of a Gaussian mixture model.

In the example illustrated in FIG. 9, the movement control unit 134 changes at least one of a rigidity and a viscosity of the part within a range in which an impedance control law represented by the following Formula (2) is maintained. As an example, in a case where a deviation in the following Formula (2) is the difference between the target position of the distal end portion of the hand portion 122 and the current position of the distal end portion of the hand portion 122, the movement control unit 134 changes the rigidity of the hand portion 122 so as to minimize the difference within a range in which the relationship between the deviation and the rigidity illustrated in the following Formula (2) and FIG. 10 is satisfied. As another example, in a case where a deviation is the difference between the target torque of the joint portion 121 and the detected torque of the joint portion 121, the movement control unit 134 changes the rigidity of the hand portion 122 so as to minimize the difference within a range in which the relationship between the deviation and the rigidity indicated in the following Formula (2) and FIG. 10 is satisfied.

$${M}^{𝒯} {\ddot{x}}_{t} = {K}_{t}^{𝒯} ( \hat{x} - {x}_{t} ) - {D}_{t}^{𝒯} {\dot{x}}_{t} + {f}_{t}^{e} \qquad ( 2 )$$

$$Where ,$$

$$e : Deviation$$

$${K}_{t}^{𝒯} : Rigidity \qquad {K}_{t}^{𝒯} = {k}_{0} + {α}_{k} {e}_{t}^{2} ( {α}_{k} : Gain )$$

$${D}_{t}^{𝒯} : Viscosity \qquad {D}_{t}^{𝒯} = {d}_{0} + {α}_{d} {e}_{t}^{2} ( {α}_{d} : Gain )$$

$${M}^{𝒯} : Inertia \qquad {M}^{𝒯} = {m}_{0}$$

In the example illustrated in FIG. 11, the movement control unit 134 changes the rigidity within a range in which an impedance control law represented by the following Formula (3) is positioned and the relationship between the deviation and the rigidity illustrated in FIG. 10 is satisfied. As an example, in a case where a deviation is a difference between the target position of the distal end portion of the hand portion 122 and the current position of the distal end portion of the hand portion 122, the movement control unit 134 changes the rigidity of the hand portion 122 so as to minimize the difference by using the first learning model 151 within a range where the following Formula (3) is satisfied.

$${M}^{𝒯} {\ddot{x}}_{t} = {K}_{t}^{𝒯} ( \hat{x} - {x}_{t} ) - {D}_{t}^{𝒯} {\dot{x}}_{t} + {f}_{t}^{e} \qquad ( 3 )$$

$$e : Deviation$$

$${K}_{t}^{𝒯} : Rigidity \qquad {K}_{t}^{𝒯} = {ϕ}^{𝒦} ( {x}_{t} , {\dot{x}}_{t} , {f}_{t}^{e} )$$

The movement control unit 134 may function as a learning unit that learns the first learning model 151 in which the passivity of the hand portion 122 is output in a case where the difference between the target position of the distal end portion of the hand portion 122 and the current position of the distal end portion of the hand portion 122 is input, by using the difference between the target position of the distal end portion of the hand portion 122 and the current position of the distal end portion of the hand portion 122 and the passivity of the hand portion 122 as teacher data. In this case, the movement control unit 134 changes the rigidity of the hand portion 122 using the learned first learning model 151. For example, in a learning phase, the movement control unit 134 causes the first learning model 151 to perform supervised learning such as machine learning (imitation learning) by using the above-described difference and the rigidity of the hand portion 122 as teacher data. As an example, the movement control unit 134 causes parameters of the first learning model 151, which is a Gaussian Mixture Model (GMM) in which a plurality of Gaussian distributions are confused as illustrated in FIG. 12, to be learned by an Expectation-Maximization (EM) algorithm. Furthermore, in an estimation phase, the movement control unit 134 estimates the rigidity of the hand portion 122 after the change, by using the Gaussian Mixture Regression (GMR) of the first learning model 151.

As another example, in a case where a deviation in the above Formula (2) is the difference between the set target torque of the joint portion 121 and the detected torque, the movement control unit 134 changes the rigidity of the hand portion 122 so as to minimize the difference by using the second learning model 152 within a range in which the above Formula (3) is satisfied. The movement control unit 134 may function as a learning unit that learns the second learning model 152 by using the difference and the passivity of the hand portion 122 as teacher data. In this case, the movement control unit 134 changes the rigidity of the hand portion 122 using the learned second learning model 152. For example, in a learning phase, the movement control unit 134 causes the second learning model 152 to perform supervised learning such as machine learning by using the difference and the rigidity of the hand portion 122 as teacher data. As an example, the movement control unit 134 causes the parameters of the second learning model 152, which is the Gaussian mixture model as illustrated in FIG. 12, to be learned by the EM algorithm. In an estimation phase, the movement control unit 134 estimates the rigidity of the hand portion 122 after the change, by using the Gaussian Mixture Regression of the second learning model 152.

Next, the configuration of the movement control unit 134 will be described in detail with reference to FIG. 4. In the example illustrated in FIG. 4, the movement control unit 134 includes the 1D Cartesian space control unit 1341 and a movement command value calculation unit 1342. The 1D Cartesian space control unit 1341 controls the movement of the part in the Cartesian space in at least the 1D direction in the Cartesian space configured from the 3D direction. For example, the 1D Cartesian space control unit 1341 controls the movement of the part in the Cartesian space in the 1D direction which is the movement direction set by the direction setting unit 1311. The 1D Cartesian space control unit 1341 includes a control space setting unit 13411 and a controller calculation unit 13412.

The control space setting unit 13411 sets a space for controlling the movement of the part based on each direction set by the direction setting unit 1311. For example, the control space setting unit 13411 sets the Cartesian space in the movement direction and the passive direction set by the direction setting unit 1311. The controller calculation unit 13412 executes calculation based on the target value set by the target value setting unit 1312 and the calculation result obtained by calculating the detection result by the kinematics calculation unit 133.

For example, the controller calculation unit 13412 calculates the difference between the target position of the distal end portion of the hand portion 122 set by the target value setting unit 1312 and the current position of the distal end portion of the hand portion 122 calculated by the kinematics calculation unit 133. The controller calculation unit 13412 calculates the difference between the target speed set by the target value setting unit 1312 and the current speed of the part calculated by the kinematics calculation unit 133. For example, the controller calculation unit 13412 calculates the difference between the target speed of the distal end portion of the hand portion 122 set by the target value setting unit 1312 and the current speed of the distal end portion of the hand portion 122 calculated by the kinematics calculation unit 133. In addition, the controller calculation unit 13412 calculates the difference between the target torque of the joint portion 121 set by the target value setting unit 1312 and the torque of the joint portion 121 calculated by the kinematics calculation unit 133.

The movement command value calculation unit 1342 calculates a value related to momentum to be commanded to the part. For example, the movement command value calculation unit 1342 calculates momentum of the translational movement and the rotational movement to be commanded to the hand portion 122 and a value of the torque to be commanded to the joint portion 121. The movement command value calculation unit 1342 includes a calculation state setting unit 13421 and an optimization calculation unit 13422.

The calculation state setting unit 13421 sets a calculation state based on the detection result acquired by the detection result acquisition unit 132 and the calculation result calculated by the controller calculation unit 13412. For example, the calculation state setting unit 13421 sets, as the calculation state, the joint state of the joint portion 121 acquired by the detection result acquisition unit 132, the difference between the target position and the current position of the part calculated by the controller calculation unit 13412, and the difference between the target speed and the current speed of the part. As an example, the calculation state setting unit 13421 sets, as the calculation state, the joint state of the joint portion 121 including the rotation angle and the torque of the joint portion 121, the difference between the target position and the current position of the distal end portion of the hand portion 122, the difference between the target speed and the current speed of the distal end portion of the hand portion 122, and the difference between the target torque of the joint portion 121 and the detected torque of the joint portion 121.

The optimization calculation unit 13422 executes optimization calculation based on the calculation state set by the calculation state setting unit 13421. For example, the optimization calculation unit 13422 minimizes the difference between the target position and the current position of the distal end portion of the hand portion 122, the difference between the target speed and the current speed of the hand portion 122, and the difference between the target torque of the joint portion 121 and the detected torque of the joint portion 121, and executes the calculation for optimizing the movements of the joint portion 121 and the hand portion 122.

The joint control unit 135 controls the joint portion 121. In the example illustrated in FIG. 4, the joint control unit 135 includes an ideal joint model generation unit 1351 and a command value calculation unit 1352. The ideal joint model generation unit 1351 generates an ideal joint model in which the movement of the joint portion 121 is optimized based on the calculation result calculated by the optimization calculation unit 13422 and the joint state of the joint portion 121 detected by the joint state detection unit 12111. The command value calculation unit 1352 calculates a command value related to the momentum of the joint portion 121 to make it into the ideal joint model generated by the ideal joint model generation unit 1351. The command value calculation unit 1352 causes the joint drive unit 1212 to drive the joint portion 121 based on the calculated command value.

The hand control unit 136 controls the hand portion 122. In the example illustrated in FIG. 4, the hand control unit 136 includes an ideal hand model generation unit 1361 and a command value calculation unit 1362. The ideal hand model generation unit 1361 generates an ideal hand model in which the movement of the hand portion 122 is optimized based on the calculation result calculated by the optimization calculation unit 13422 and the information regarding the hand portion 122 detected by the detection unit 1221. The command value calculation unit 1362 calculates a command value related to the momentum of the hand portion 122 to make it into the ideal hand model generated by the ideal hand model generation unit 1361. The command value calculation unit 1362 causes the hand drive unit 1222 to drive the hand portion 122 based on the calculated command value.

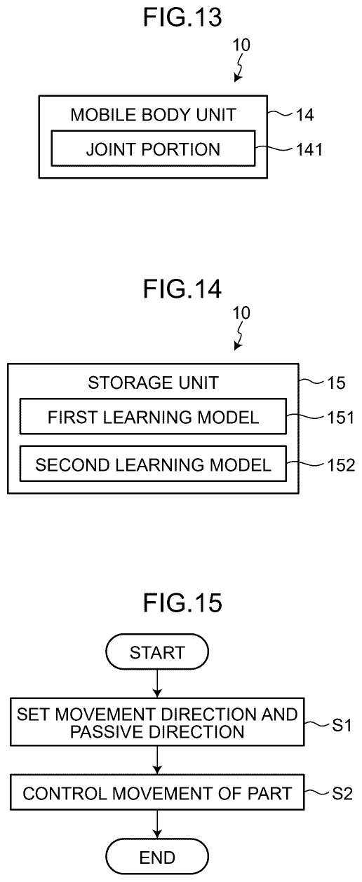

The description returns to FIG. 1. The mobile body unit 14 moves the robot 10. For example, when the robot 10 is a humanoid robot, the mobile body unit 14 is a part corresponding to a foot portion. Hereinafter, a configuration of the mobile body unit 14 will be described with reference to FIG. 13. FIG. 13 is a diagram illustrating an example of a configuration of the mobile body unit. In the example illustrated in FIG. 13, the mobile body unit 14 includes a joint portion 141.

The joint portion 141 is a part corresponding to a joint of the mobile body unit 14. In a case where the robot 10 is a humanoid robot, examples of the joint portion 141 include a joint portion of a foot portion and the like. The mobile body unit 14 may further include a member corresponding to at least one of the above-described rotation angle detection unit 121111 and the joint drive unit 1212.

The description returns to FIG. 1. The storage unit 15 stores various types of information such as a movement direction, a passive direction, a translation direction, a rotation direction, environment information, a current position, a target position, a current speed, a target speed, a state of the joint portion 121, a target torque of the joint portion 121, and a detected torque of the joint portion 121. Examples of the storage unit 15 include a storage device such as a hard disk drive (HDD), a solid state drive (SSD), and an optical disk, and a semiconductor memory capable of rewriting data, such as a random access memory (RAM), a flash memory, and a non-volatile static random access memory (NVSRAM). The storage unit 15 stores an operating system (OS) executed by the robot 10 and various programs. Hereinafter, a configuration of the storage unit 15 will be described with reference to FIG. 14. FIG. 14 is a diagram illustrating an example of a configuration of a storage unit. The storage unit 15 includes the first learning model 151 and the second learning model 152.

Next, an example of a flow of processing by the robot 10 according to the first embodiment will be described with reference to FIG. 15. FIG. 15 is a diagram illustrating an example of a flow of processing by the robot according to the first embodiment.

In Step S1, the direction setting unit 1311 of the robot 10 sets a movement direction in which at least one part of the robot 10 is caused to move and a passive direction in which the part has passivity.

In Step S2, the movement control unit 134 of the robot 10 controls the movement of the part based on the movement direction and the passive direction set by the direction setting unit 1311.

### 2. Second Embodiment

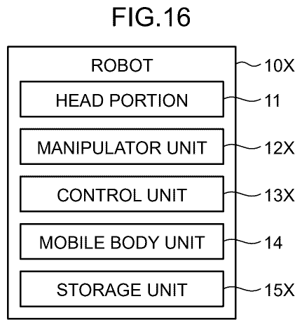

The manipulator according to one aspect of the present disclosure may control the movement of the hand portion further based on a contact state between the object and the distal end portion of the hand portion. Hereinafter, a configuration of a robot 10X according to a second embodiment will be described with reference to FIG. 16. FIG. 16 is a diagram illustrating an example of a schematic configuration of a robot according to a second embodiment.

In the example illustrated in FIG. 16, the robot 10X includes a manipulator unit 12X, a control unit 13X, and a storage unit 15X instead of the manipulator unit 12, the control unit 13, and the storage unit 15 of the robot 10 according to the first embodiment. Other than this point, the robot 10X is similar to the robot 10 according to the first embodiment.

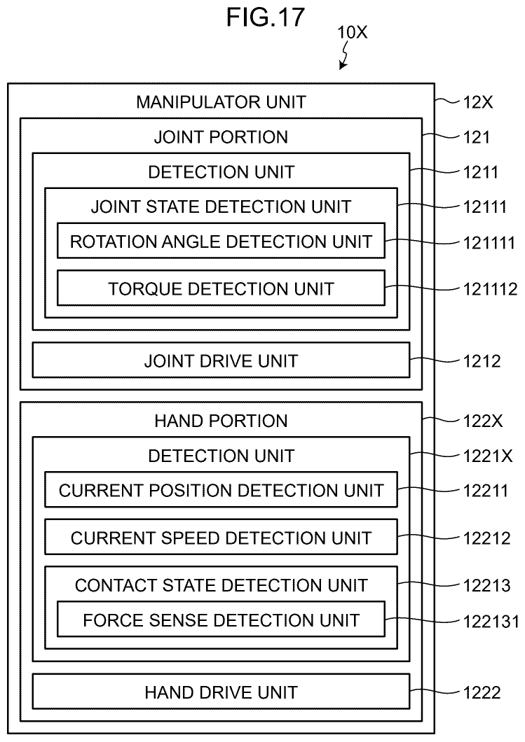

Hereinafter, a configuration of the manipulator unit 12X will be described with reference to FIG. 17. FIG. 17 is a diagram illustrating an example of a configuration of a manipulator unit in the second embodiment. As illustrated in FIG. 17, the manipulator unit 12X includes a hand portion 122X instead of the hand portion 122 in the first embodiment. Other than this point, the manipulator unit 12X is similar to the manipulator unit 12 in the first embodiment.

The hand portion 122X further includes a contact state detection unit 12213 at a distal end portion of the hand portion 122X. Other than this point, the hand portion 122X is similar to the hand portion 122 in the first embodiment. The contact state detection unit 12213 detects a contact state between the object and the distal end portion of the hand portion 122X. The contact state detection unit 12213 includes a force sense detection unit 122131. The force sense detection unit 122131 detects a force of the hand portion 122X in at least one of the movement direction and the passive direction.

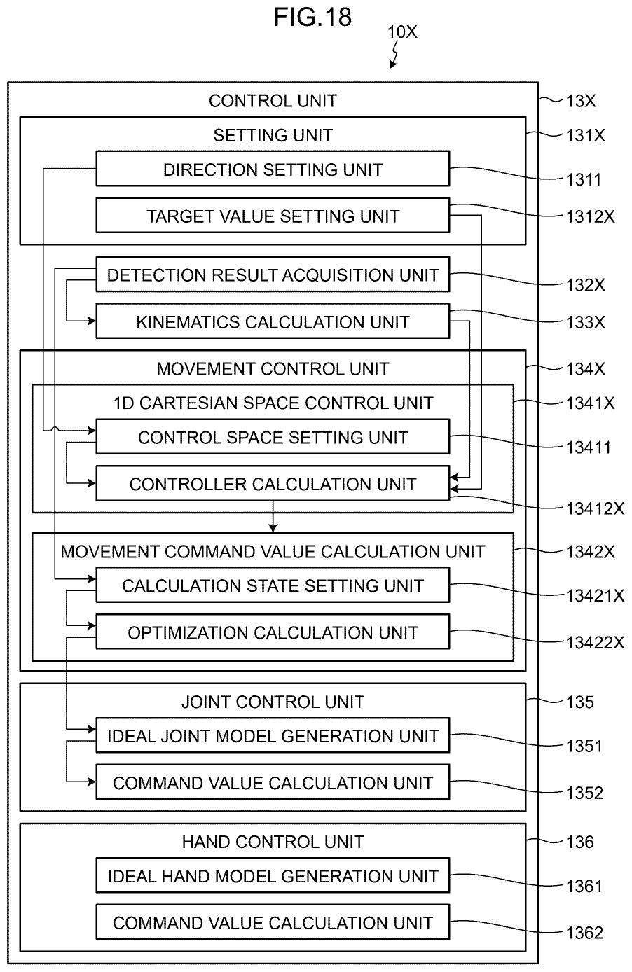

A configuration of the control unit 13X will be described below with reference to FIG. 18. FIG. 18 is a diagram illustrating an example of a configuration of a control unit in the second embodiment. As illustrated in FIG. 18, instead of the setting unit 131, the detection result acquisition unit 132, the kinematics calculation unit 133, and the movement control unit 134 in the first embodiment, the control unit 13X includes a setting unit 131X, a detection result acquisition unit 132X, a kinematics calculation unit 133X, and a movement control unit 134X. Other than this point, the control unit 13X is similar to the control unit 13 in the first embodiment.

The setting unit 131X includes a target value setting unit 1312X instead of the target value setting unit 1312 in the first embodiment. Other than this point, the setting unit 131X is similar to the setting unit 131 in the first embodiment. The target value setting unit 1312X further sets a target value of the force of the hand portion 122X in at least one of the movement direction and the passive direction.

The detection result acquisition unit 132X further acquires, as the detection result, the contact state between the hand portion 122X and the object detected by the contact state detection unit 12213 in a detection unit 1221X. The detection result acquisition unit 132X further acquires, as the detection result, the force of the hand portion 122X detected by the force sense detection unit 122131 in the contact state detection unit 12213.

The kinematics calculation unit 133X executes calculation further based on the contact state between the hand portion 122X and the object and the force of the hand portion 122X acquired by the detection result acquisition unit 132X.

The movement control unit 134X controls the movement of the hand portion 122X further based on the contact state detected by the contact state detection unit 2213. For example, in a case where the hand portion 122X is not in contact with the object, the movement control unit 134X causes the hand portion 122X to execute a movement of bringing the hand portion into contact with the object. Hereinafter, before describing a configuration of the movement control unit 134X, an outline of the movement control unit 134X will be described.

The movement control unit 134X may control the movement of the hand portion 122X further based on the force of the hand portion 122X detected by the force sense detection unit 122131. For example, the movement control unit 134X controls the movement of the hand portion 122X so that the detected force of the hand portion 122X falls within a predetermined range. The movement control unit 134X may control the movement of the hand portion 122X based on a difference between the target value of the force of the hand portion 122X set by the target value setting unit 1312X and the force of the hand portion 122X detected by the force sense detection unit 122131. For example, the movement control unit 134X controls the force of the hand portion 122X so as to reduce the difference between the set target value of the force of the hand portion 122X and the detected force of the hand portion 122X.

The movement control unit 134X may further control the passivity of the hand portion 122X based on the force of the hand portion 122X detected by the force sense detection unit 122131. For example, the movement control unit 134X controls the passivity of the hand portion 122X so that the force of the hand portion 122X falls within a predetermined range. The movement control unit 134X may control the passivity of the hand portion 122X based on the difference between the target value of the force of the hand portion 122X set by the target value setting unit 1312X and the force of the hand portion 122X detected by the force sense detection unit 122131. For example, the movement control unit 134X controls the passivity of the hand portion 122X so as to reduce the difference.

The movement control unit 134X may control the passivity of the hand portion 122X by using a third learning model 153. For example, the movement control unit 134X uses the third learning model 153 to control the passivity of the hand portion 122X so as to reduce the difference. In the third learning model 153, when the difference between the target value of the force of the hand portion 122X set by the target value setting unit 1312X and the force of the hand portion 122X detected by the force sense detection unit 122131 is input, the passivity of the hand portion 122X is output. Details of the third learning model 153 will be described later.

For example, the movement control unit 134X changes at least one of a rigidity and a viscosity of the hand portion 122X within a range in which the impedance control law represented by the above Formula (2) is maintained. In a case where a deviation is the difference between the target value of the force of the hand portion 122X and the detected force of the hand portion 122x, the movement control unit 134X changes the rigidity of the hand portion 122X so as to minimize the difference within a range in which the relationship between the deviation and the rigidity indicated in the above Formula (2) and FIG. 10 is satisfied. The movement control unit 134X changes the rigidity of the part of the hand portion 122X so as to minimize the difference by using the third learning model 153 within a range in which the above-described Formula (3) is satisfied.

In this case, the movement control unit 134X may function as a learning unit that learns the third learning model 153 by using the above-described difference and the passivity of the hand portion 122X as teacher data, and may change the rigidity of the hand portion 122X by using the learned third learning model 153. For example, in a learning phase, the movement control unit 134X causes the third learning model 153 to perform supervised learning such as machine learning by using the above-described difference and a rigidity of the part as teacher data. As an example, the movement control unit 134X causes the parameters of the third learning model 153, which is the Gaussian mixture model as illustrated in FIG. 12, to be learned by the EM algorithm. In an estimation phase, the movement control unit 134X estimates the rigidity of the hand portion 122X after the change, by using the Gaussian Mixture Regression of the third learning model 153.

Next, the configuration of the movement control unit 134X will be described in detail with reference to FIG. 18. In the example illustrated in FIG. 18, the movement control unit 134X includes a 1D Cartesian space control unit 1341X and a movement command value calculation unit 1342X instead of the 1D Cartesian space control unit 1341 and the movement command value calculation unit 1342 in the first embodiment. Other than this point, the movement control unit 134X is similar to the movement control unit 134 in the first embodiment. The 1D Cartesian space control unit 1341X includes a controller calculation unit 13412X instead of the controller calculation unit 13412 in the first embodiment. Other than this point, the 1D Cartesian space control unit 1341X is similar to the 1D Cartesian space control unit 1341 in the first embodiment.

The controller calculation unit 13412X further calculates a difference between the target value of the force of the hand portion 122 set by the target value setting unit 1312X and the force of the hand portion 122X calculated by the kinematics calculation unit 133X.

In the example illustrated in FIG. 18, the movement command value calculation unit 1342X includes a calculation state setting unit 13421X and an optimization calculation unit 13422X instead of the calculation state setting unit 13421 and the optimization calculation unit 13422 in the first embodiment. Other than this point, the movement command value calculation unit 1342X is similar to the movement command value calculation unit 1342 in the first embodiment.

The calculation state setting unit 13421X sets a calculation state further based on the force of the hand portion 122X acquired by the detection result acquisition unit 132X and the calculation result of the difference between the target value of the force of the hand portion 122X calculated by the controller calculation unit 13412X and the detected force of the hand portion 122X. For example, the calculation state setting unit 13421X sets, as the calculation state, the calculation result of the difference between the target value of the force of the hand portion 122X and the detected force of the hand portion 122X.

The optimization calculation unit 13422X further executes calculation for optimizing the movement of the hand portion 122X further based on the calculation result of the difference between the target value of the force of the hand portion 122X and the detected force of the hand portion 122X set by the calculation state setting unit 13421X.

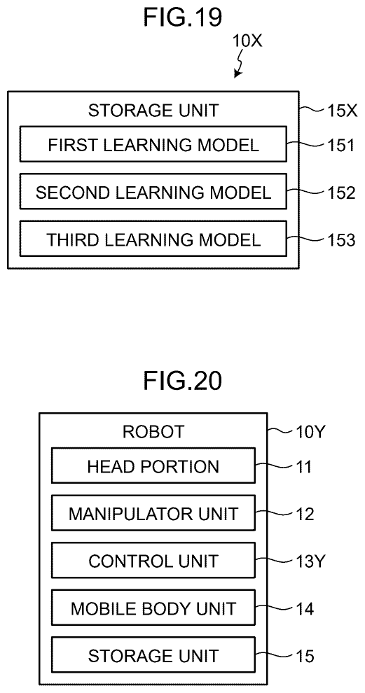

Next, an example of a configuration of the storage unit 15X will be described with reference to FIG. 19. FIG. 19 is a diagram illustrating an example of a configuration of a storage unit in the second embodiment. In the example illustrated in FIG. 19, the storage unit 15X further includes the third learning model 153. Other than this point, the storage unit 15X is similar to the storage unit 15 in the first embodiment.

### 3. Third Embodiment

The manipulator according to one aspect of the present disclosure may further set a task of the manipulator, and set a movement direction and a passive direction based on the set task. Hereinafter, a configuration of a robot 10Y according to a third embodiment will be described with reference to FIG. 20. FIG. 20 is a diagram illustrating an example of a schematic configuration of a robot according to the third embodiment.

In the example illustrated in FIG. 20, the robot 10Y includes a control unit 13Y instead of the control unit 13 of the robot 10 according to the first embodiment. Other than this point, the robot 10Y is similar to the robot 10 according to the first embodiment.

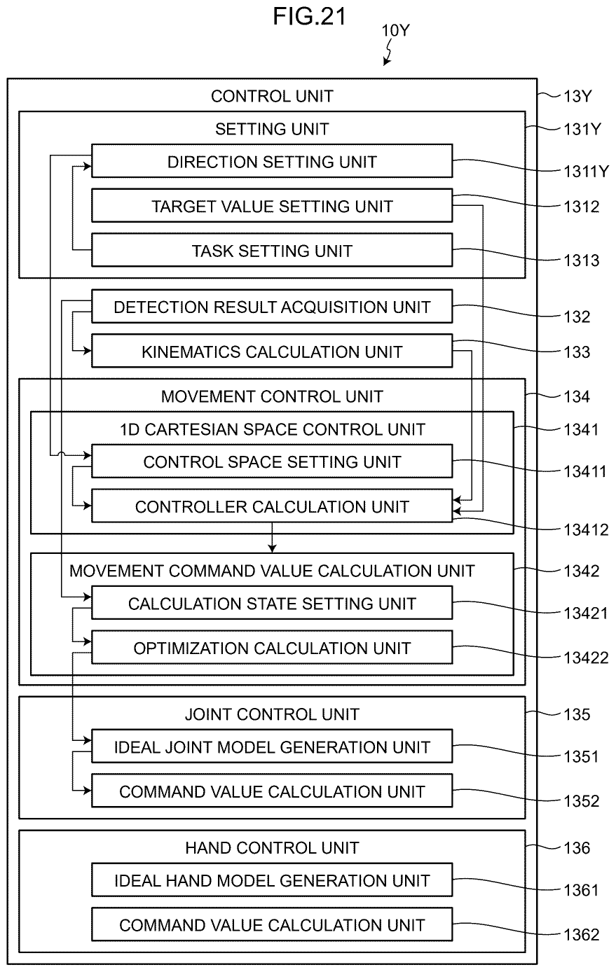

Hereinafter, a configuration of the control unit 13Y will be described with reference to FIG. 21. FIG. 21 is a diagram illustrating an example of a configuration of a control unit in the third embodiment. As illustrated in FIG. 21, the control unit 13Y includes a setting unit 131Y instead of the setting unit 131 in the first embodiment. Other than this point, the control unit 13Y is similar to the control unit 13 in the first embodiment.

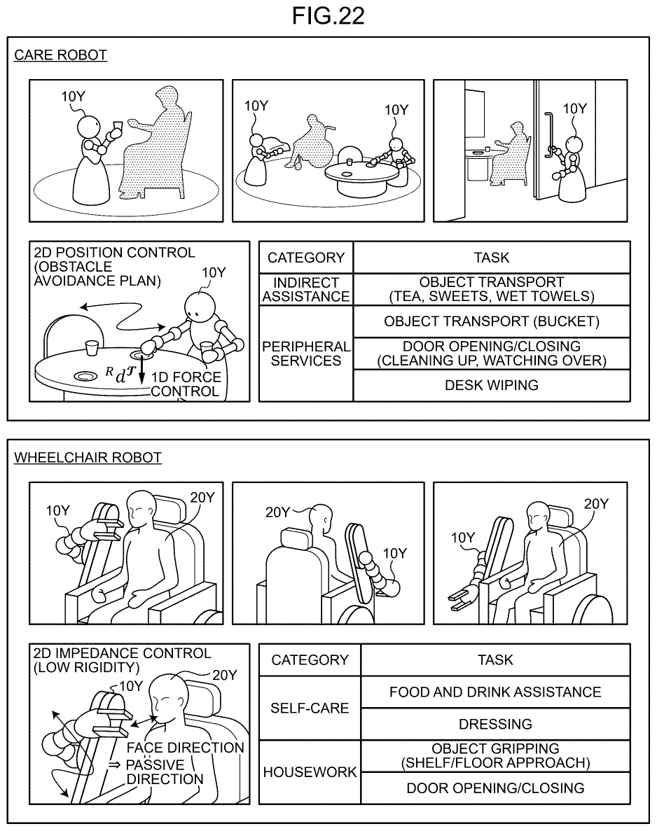

The setting unit 131Y further includes a task setting unit (setting unit) 1313, and includes a direction setting unit 1311Y instead of the direction setting unit 1311 in the first embodiment. Other than this point, the setting unit 131Y is similar to the setting unit 131 in the first embodiment. The task setting unit 1313 sets a task of the robot 10Y. The direction setting unit 1211Y sets a movement direction and a passive direction based on the task set by the task setting unit 1313. Hereinafter, an example of setting by the setting unit 131Y of the robot 10Y will be described with reference to FIG. 22. FIG. 22 is a diagram for describing an example of setting by the robot according to the third embodiment.

As illustrated in the diagram of a care robot in FIG. 22, in a case where the robot 10Y is a care robot in an elderly facility, and the task setting unit 1313 sets desk wiping as a task, the direction setting unit 1311Y sets a movement direction to a 2D direction horizontal to a surface of the desk, and sets the movement direction to a translation direction. In addition, the direction setting unit 1311Y sets a passive direction to a 1D direction, which is a vertical downward direction with respect to the surface of the desk, and sets the passive direction to a rotation direction. As illustrated in the diagram of a wheelchair robot in FIG. 22, in a case where the robot 10Y is a wheelchair robot and the task setting unit 1313 sets food and drink assistance as a task, the direction setting unit 1311Y sets a movement direction and a passive direction in which a risk of contact with a face of a user 20Y is avoided. For example, the direction setting unit 1311Y sets the movement direction to a 2D direction perpendicular to a face direction toward the face of the user 20Y, and sets the passive direction to the face direction and the 1D direction opposite to the face direction.

### 4. Example of Hardware Configuration

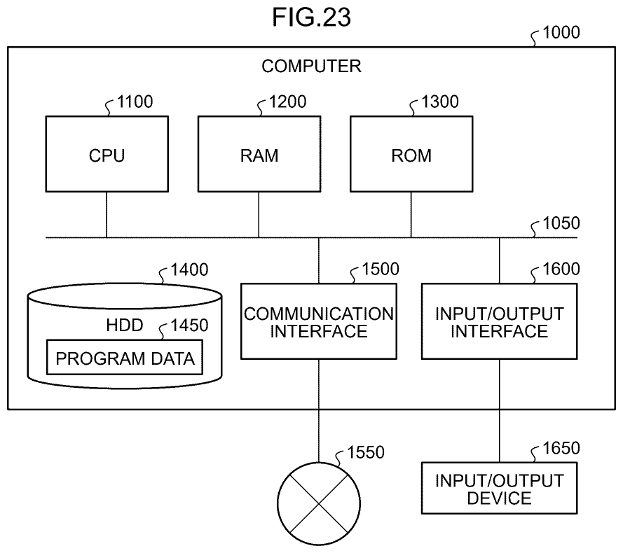

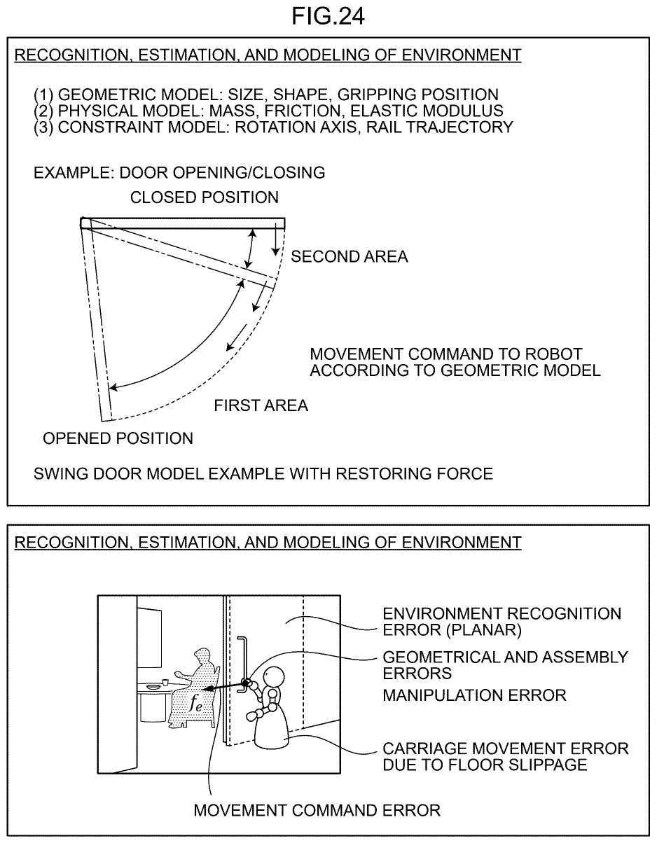

Various apparatuses such as the robot 10, the robot 10X, and the robot 10Y described above can include a computer. An example will be described with reference to FIG. 23.

FIG. 23 is a block diagram illustrating an example of a hardware configuration of the apparatus. An exemplified computer 1000 includes a CPU 1100, a RAM 1200, a read only memory (ROM) 1300, an HDD 1400, a communication interface 1500, and an input/output interface 1600. Each unit of the computer 1000 is coupled by a bus 1050.

The CPU 1100 operates based on a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program that depends on hardware of the computer 1000, and the like.

The HDD 1400 is a computer-readable recording medium that non-transiently records a program executed by the CPU 1100, data used by the program, and the like. Specifically, the HDD 1400 is a recording medium that records a generation program for executing each operation according to the present disclosure which is an example of program data 1450.

The communication interface 1500 is an interface for the computer 1000 to couple to an external network 1550 (for example, the Internet). For example, the CPU 1100 receives data from another equipment or transmits data generated by the CPU 1100 to another equipment via the communication interface 1500.

The input/output interface 1600 is an interface for coupling an input/output device 1650 to the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Further, the input/output interface 1600 may function as a media interface that reads a program or the like recorded in a predetermined recording medium (medium). The medium is an optical recording medium such as a digital versatile disc (DVD) and a phase change rewritable disk (PD), a magneto-optical recording medium such as a magneto-optical disk (MO), a tape medium, a magnetic recording medium, a semiconductor memory, and the like.

At least some of the functions of the robot 10, the robot 10X, the robot 10Y, and the like described above may be realized, for example, by the CPU 1100 of the computer 1000 executing a program loaded on the RAM 1200. In addition, the HDD 1400 stores a program and the like according to the present disclosure. Note that the CPU 1100 reads the program data 1450 from the HDD 1400 and executes the program data, but as another example, these programs may be acquired from another apparatus via the external network 1550.

### 5. Example of Effects

As described with reference to FIGS. 1 to 22 and the like, one of the disclosed techniques is the robot 10 and the like. As described with reference to FIGS. 1 to 22 and the like, the robot 10 is the robot 10 including the setting unit 131 that sets the movement direction in which at least one part of the robot 10 is caused to move and the passive direction in which the part has passivity, and the movement control unit 134 that controls the movement of the part based on the movement direction and the passive direction set by the setting unit 131.

The robot 10 enables execution of the task without detailed information such as an environment model, only by using a small amount of information by setting a movement direction in which the movement is realized and controlling the movement of the part. In addition, the robot 10 sets a passive direction adapted to a fluctuation in an environment and controls the movement of the part, thereby making it possible to cause the part to execute a target movement according to the task while being compatible with the environment in a state having robustness against an environment recognition error and a movement error. Therefore, the robot 10 can reduce instability of the movement from the movement error of the part, and as a result, a task success rate can be improved. From the above, the robot 10 enables execution of the task with a high success rate without detailed information.

As described with reference to FIGS. 1 to 22 and the like, the robot 10 may further include the environment information acquisition unit 111 that acquires environment information regarding the environment around the robot 10, and the setting unit 131 may set the movement direction and the passive direction based on the environment information acquired by the environment information acquisition unit 111. As a result, the robot 10 does not require a detailed environment model such as a geometric model, a physical model, and a constraint model, and can easily set the movement direction and the passive direction having a high task success rate based on simple environment information such as imaging information.

As described with reference to FIGS. 1 to 22 and the like, the environment information acquisition unit 111 may acquire environment information including an object, and the setting unit 131 may set the movement direction and the passive direction based on the object included in the environment information acquired by the environment information acquisition unit 111. As a result, the robot 10 can set the movement direction and the passive direction to further increase the success rate of the task based on the environment information including the object that is a work target of the task.

As described with reference to FIGS. 1 to 22 and the like, the environment information acquisition unit 111 may acquire environment information including the door, and the setting unit 131 may set the movement direction and the passive direction based on the type of the door included in the environment information acquired by the environment information acquisition unit 111. As a result, since the robot 10 can set the movement direction and the passive direction different according to the type of the door, it is possible to set the movement direction and the passive direction to further increase the success rate of the task.

As described with reference to FIGS. 1 to 22 and the like, the movement control unit 134 may cause the part to move in the movement direction when the part comes into contact with the object. As a result, the robot 10 enables execution of a manipulation task under the environment contact with a high success rate without detailed information.

As described with reference to FIGS. 1 to 22 and the like, the setting unit 131 may set the movement direction to a translation direction in which the part is caused to execute a translational movement, and set the passive direction to a rotation direction along a rotation axis in which the part is caused to execute a rotational movement, and the movement control unit 134 may cause the part to execute the translational movement and the rotational movement based on the movement direction and the passive direction set by the setting unit 131.

As a result, as long as the movement direction is set, the robot 10 does not update the movement direction and the passive direction according to the change in the environment each time, and can maintain the translational movement in the constrained movement direction while having the passivity by the rotational movement even when a disturbance is given. For example, as long as the movement direction in which the knob is lowered and the movement direction in which the door main body is pushed are set, the robot 10 enables a movement such as a translational movement in which the knob is lowered and a translational movement in which the door main body is pushed without detailed information such as an open/close state, an inclination, and a reaction force direction of the door.

As described with reference to FIGS. 1 to 22 and the like, the robot 10 may further include the current position detection unit 12211 that detects the current position of the part, the setting unit 131 may further set the target position of the part, and the movement control unit 134 may cause the part to execute the translational movement from the current position detected by the current position detection unit 12211 to the target position set by the setting unit 131. As a result, the robot 10 can execute the task of causing the part to execute the translational movement with a high success rate.

As described with reference to FIGS. 1 to 22 and the like, the robot 10 may further include the current speed detection unit 12212 that detects the current speed of the part, the setting unit 131 may further set the target speed of the part, and the movement control unit 134 may cause the part to execute the translational movement so that the current speed detected by the current speed detection unit 12212 becomes the target speed set by the setting unit 131. As a result, the robot 10 can execute the task of causing the part to execute the translational movement with a high success rate.

As described with reference to FIGS. 1 to 22 and the like, the robot 10 may further include the elastic joint portion 121 around the part. As a result, since the robot 10 can cause the joint portion 121 to have passivity, it is possible to cause the joint portion 121 to execute the movement according to the fluctuation in the environment such as the movement of the part in the passive direction.

As described with reference to FIGS. 1 to 22 and the like, the joint portion 121 may include the joint state detection unit 12111 in which the state of the joint portion 121 is detected, and the movement control unit 134 may control the movement of the part further based on the state of the joint portion 121 detected by the joint state detection unit 12111. As a result, the robot 10 can control the movement of the part so as to adapt to the state of the joint portion 121, thereby enabling execution of the task with a higher success rate.

As described with reference to FIGS. 1 to 22 and the like, the joint state detection unit 12111 may include the torque detection unit 121112 in which the torque of the joint portion 121 is detected, and the movement control unit 134 may control the movement of the part further based on the torque of the joint portion 121 detected by the torque detection unit 121112. As a result, the robot 10 can control the movement of the part so as to adapt to the torque of the joint portion 121, thereby enabling execution of the task with a higher success rate.

As described with reference to FIGS. 1 to 22 and the like, the movement control unit 134 may further control the passivity of the part based on the torque of the joint portion 121 detected by the torque detection unit 121112. As a result, the robot 10 can control the passivity of the part so as to adapt to the torque of the joint portion 121, thereby enabling execution of the task with a higher success rate.

As described with reference to FIGS. 1 to 22 and the like, the setting unit 131 may further set the target torque of the joint portion 121, and the movement control unit 134 may control the passivity of the part based on the difference between the target torque of the joint portion 121 set by the setting unit 131 and the torque of the joint portion 121 detected by the torque detection unit 121112. As a result, the robot 10 can control the passivity of the part so as to reduce the difference between the target torque of the joint portion 121 and the detected torque of the joint portion 121, thereby enabling execution of the task with a higher success rate.

As described with reference to FIGS. 1 to 22 and the like, the setting unit 131 may set the movement direction in which the hand portion 122 of the robot 10 is caused to move and the passive direction in which the hand portion 122 has passivity, the hand portion 122 may include the contact state detection unit 12213 that detects the contact state between the object and the distal end portion of the hand portion 122 at the distal end portion of the hand portion 122, and the movement control unit 134 may control the movement of the hand portion 122 further based on the contact state detected by the contact state detection unit 12213. As a result, the robot 10 can control the movement of the hand portion 122 to adapt to the contact state, thereby enabling execution of the task with a higher success rate.

As described with reference to FIGS. 1 to 22 and the like, the contact state detection unit 12213 may include the force sense detection unit 122131 that detects the force of the hand portion 122 in at least one of the movement direction and the passive direction, and the movement control unit 134 may control the movement of the hand portion 122 further based on the force of the hand portion 122 detected by the force sense detection unit 122131. As a result, the robot 10 can control the movement of the hand portion 122 so as to adapt to the force of the hand portion 122, thereby enabling execution of the task with a higher success rate.

As described with reference to FIGS. 1 to 22 and the like, the movement control unit 134 may further control the passivity of the hand portion 122 based on the force of the hand portion 122 detected by the force sense detection unit 122131. As a result, the robot 10 can control the passivity of the hand portion 122 so as to adapt to the force of the hand portion 122, thereby enabling execution of the task with a higher success rate.

As described with reference to FIGS. 1 to 22 and the like, the movement control unit 134 may control the passivity of the hand portion 122 based on the difference between the target position of the distal end portion of the hand portion 122 and the current position of the distal end portion of the hand portion 122. As a result, the robot 10 can control the passivity of the hand portion 122 so as to reduce the difference between the target position of the distal end portion of the hand portion 122 and the current position of the distal end portion of the hand portion 122, thereby enabling execution of the task with a higher success rate.

As described with reference to FIGS. 1 to 22 and the like, the robot 10 may further include the learning unit that learns the first learning model 151 in which the passivity of the hand portion 122 is output in a case where the difference between the target position of the distal end portion of the hand portion 122 and the current position of the distal end portion of the hand portion 122 is input, by using the difference between the target position of the distal end portion of the hand portion 122 and the current position of the distal end portion of the hand portion 122 and the passivity of the hand portion 122 as the teacher data, and the movement control unit 134 may control the passivity of the hand portion 122 by using the first learning model 151. As a result, the robot 10 can control the passivity of the hand portion 122 so as to reduce the difference between the target position of the distal end portion of the hand portion 122 and the current position of the distal end portion of the hand portion 122, thereby enabling execution of the task with a higher success rate. Furthermore, the robot 10 learns the first learning model 151, thereby making it possible to further enhance robustness against the fluctuation in the environment.

As described with reference to FIGS. 1 to 22 and the like, the setting unit 131 may further set the task of the robot 10, and set the movement direction and the passive direction based on the set task. As a result, the robot 10 can be applied to various tasks.

The method for controlling the robot 10 described with reference to FIGS. 1 to 22 and the like is also one of the disclosed techniques. A method for controlling the robot 10 is a method for controlling the robot 10 executed by the robot 10, and includes a setting step (Step S1) of setting a movement direction in which at least one part of the robot 10 is caused to move and a passive direction in which the part has passivity, and a control step (Step S2) of controlling the movement of the part based on the movement direction and the passive direction set in the setting step. Also by such a method for controlling the robot 10, as described above, the task can be executed with a high success rate without detailed information.

The effects described in the present disclosure are merely examples, and are not limited to the disclosed contents. Other effects may be provided.

Although the embodiments of the present disclosure have been described above, the technical scope of the present disclosure is not limited to the above-described embodiments as they are, and various modifications can be made without departing from the gist of the present disclosure, and different components in the modifications may be appropriately combined.

Note that the present technique can be related to goal 9 “Industry, innovation, infrastructure” of the Sustainable Development Goals (SDGs) adopted at the UN summit in 2015.

Note that the present technique can also have the following configurations.

(1) A manipulator comprising:
a setting unit configured to set a movement direction in which at least one part of the manipulator is caused to move and a passive direction in which the part has passivity; and
a control unit configured to control a movement of the part based on the movement direction and the passive direction set by the setting unit.
   (2) The manipulator according to (1), further comprising:
an acquisition unit configured to acquire environment information regarding an environment around the manipulator, wherein
the setting unit sets the movement direction and the passive direction based on the environment information acquired by the acquisition unit.
   (3) The manipulator according to (1) or (2), wherein
the acquisition unit acquires the environment information including an object, and
the setting unit sets the movement direction and the passive direction based on the object included in the environment information acquired by the acquisition unit.
   (4) The manipulator according to (3), wherein
the acquisition unit acquires the environment information including a door, and
the setting unit sets the movement direction and the passive direction based on a type of the door included in the environment information acquired by the acquisition unit.
   (5) The manipulator according to (3) or (4), wherein
the control unit causes the part to move in the movement direction when the part comes into contact with the object.
   (6) The manipulator according to any one of (1) to (5), wherein
the setting unit sets the movement direction to a translation direction in which the part is caused to execute a translational movement, and sets the passive direction to a rotation direction along a rotation axis in which the part is caused to execute a rotational movement, and
the control unit causes the part to execute the translational movement and the rotational movement based on the movement direction and the passive direction set by the setting unit.
   (7) The manipulator according to (6), further comprising:
a current position detection unit configured to detect a current position of the part, wherein
the setting unit further sets a target position of the part, and
the control unit causes the part to execute the translational movement from the current position detected by the current position detection unit to the target position set by the setting unit.
   (8) The manipulator according to (6), further comprising:
a current speed detection unit configured to detect a current speed of the part, wherein
the setting unit further sets a target speed of the part, and
the control unit causes the part to execute the translational movement such that the current speed detected by the current speed detection unit becomes the target speed set by the setting unit.
   (9) The manipulator according to any one of (1) to (8), further comprising:
an elastic joint portion around the part.
   (10) The manipulator according to (9), wherein
the joint portion includes a joint state detection unit in which a state of the joint portion is detected, and
the control unit controls the movement of the part further based on the state of the joint portion detected by the joint state detection unit.
   (11) The manipulator according to (10), wherein
the joint state detection unit includes a torque detection unit that detects a torque of the joint portion, and
the control unit controls the movement of the part further based on the torque of the joint portion detected by the torque detection unit.
   (12) The manipulator according to (11), wherein
the control unit further controls passivity of the part based on the torque of the joint portion detected by the torque detection unit.
   (13) The manipulator according to (12), wherein
the setting unit further sets a target torque of the joint portion, and
the control unit controls the passivity of the part based on a difference between the target torque of the joint portion set by the setting unit and the torque of the joint portion detected by the torque detection unit.
   (14) The manipulator according to (7), wherein
the setting unit sets the movement direction in which a hand portion of the manipulator is caused to move and the passive direction in which the hand portion has passivity,
the hand portion includes a contact state detection unit that detects a contact state between the object and a distal end portion of the hand portion at the distal end portion of the hand portion, and
the control unit controls a movement of the hand portion further based on the contact state detected by the contact state detection unit.
   (15) The manipulator according to (14), wherein
the contact state detection unit includes a force sense detection unit that detects a force of the hand portion in at least one of the movement direction and the passive direction, and
the control unit controls the movement of the hand portion further based on the force of the hand portion detected by the force sense detection unit.
   (16) The manipulator according to (15), wherein
the control unit further controls passivity of the hand portion based on the force of the hand portion detected by the force sense detection unit.
   (17) The manipulator according to (16), wherein
the control unit controls the passivity of the hand portion based on a difference between the target position of the distal end portion of the hand portion and the current position of the distal end portion of the hand portion.
   (18) The manipulator according to (17), further comprising:
a learning unit configured to learn a learning model in which the passivity of the hand portion is output in a case where the difference between the target position of the distal end portion of the hand portion and the current position of the distal end portion of the hand portion is input, by using the difference between the target position of the distal end portion of the hand portion and the current position of the distal end portion of the hand portion and the passivity of the hand portion as teacher data, wherein
the control unit controls the passivity of the hand portion by using the learning unit.
   (19) The manipulator according to any one of (1) to (18), wherein
the setting unit further sets a task of the manipulator, and sets the movement direction and the passive direction based on the set task.
   (20) A method for controlling a manipulator executed by a manipulator, the method comprising:
a setting step of setting a movement direction in which at least one part of the manipulator is caused to move and a passive direction in which the part has passivity; and
a control step of controlling a movement of the part based on the movement direction and the passive direction set by the setting step.

### REFERENCE SIGNS LIST

10, 10X, 10Y ROBOT
11 HEAD PORTION
12, 12X MANIPULATOR UNIT
13, 13X, 13Y CONTROL UNIT
14 MOBILE BODY UNIT
15, 15X STORAGE UNIT
20, 20α, 20β, 20γ DOOR
20Y USER
111 ENVIRONMENT INFORMATION ACQUISITION UNIT (ACQUISITION UNIT)
121 JOINT PORTION
122, 122X HAND PORTION
131, 131X 131Y SETTING UNIT
132, 132X DETECTION RESULT ACQUISITION UNIT
133, 133X KINEMATICS CALCULATION UNIT
134, 134X MOVEMENT CONTROL UNIT
135 JOINT CONTROL UNIT
136 HAND CONTROL UNIT
141 JOINT PORTION
151 FIRST LEARNING MODEL (LEARNING MODEL)
152 SECOND LEARNING MODEL
153 THIRD LEARNING MODEL
1211, 1221, 1221X DETECTION UNIT
1212 JOINT DRIVE UNIT
1222 HAND DRIVE UNIT
1311, 1311Y DIRECTION SETTING UNIT (SETTING UNIT)
1312, 1312X TARGET VALUE SETTING UNIT (SETTING UNIT)
1313 TASK SETTING UNIT (SETTING UNIT)
1341, 1341X 1D CARTESIAN SPACE CONTROL UNIT
1342, 1342X MOVEMENT COMMAND VALUE CALCULATION UNIT
1351 IDEAL JOINT MODEL GENERATION UNIT
1352 COMMAND VALUE CALCULATION UNIT
1361 IDEAL HAND MODEL GENERATION UNIT
1362 COMMAND VALUE CALCULATION UNIT
12111 JOINT STATE DETECTION UNIT
12211 CURRENT POSITION DETECTION UNIT
12212 CURRENT SPEED DETECTION UNIT
12213 CONTACT STATE DETECTION UNIT
13411 CONTROL SPACE SETTING UNIT
13412, 13412X CONTROLLER CALCULATION UNIT
13421, 13421X CALCULATION STATE SETTING UNIT
13422, 13422X OPTIMIZATION CALCULATION UNIT
121111 ROTATION ANGLE DETECTION UNIT
121112 TORQUE DETECTION UNIT
122131 FORCE SENSE DETECTION UNIT

1. A manipulator comprising:
a setting unit configured to set a movement direction in which at least one part of the manipulator is caused to move and a passive direction in which the part has passivity; and
a control unit configured to control a movement of the part based on the movement direction and the passive direction set by the setting unit.

2. The manipulator according to claim 1, further comprising:
an acquisition unit configured to acquire environment information regarding an environment around the manipulator, wherein
the setting unit sets the movement direction and the passive direction based on the environment information acquired by the acquisition unit.

3. The manipulator according to claim 2, wherein
the acquisition unit acquires the environment information including an object, and
the setting unit sets the movement direction and the passive direction based on the object included in the environment information acquired by the acquisition unit.

4. The manipulator according to claim 3, wherein
the acquisition unit acquires the environment information including a door, and
the setting unit sets the movement direction and the passive direction based on a type of the door included in the environment information acquired by the acquisition unit.

5. The manipulator according to claim 4, wherein
the control unit causes the part to move in the movement direction when the part comes into contact with the object.

6. The manipulator according to claim 5, wherein
the setting unit sets the movement direction to a translation direction in which the part is caused to execute a translational movement, and sets the passive direction to a rotation direction along a rotation axis in which the part is caused to execute a rotational movement, and
the control unit causes the part to execute the translational movement and the rotational movement based on the movement direction and the passive direction set by the setting unit.

7. The manipulator according to claim 6, further comprising:
a current position detection unit configured to detect a current position of the part, wherein
the setting unit further sets a target position of the part, and
the control unit causes the part to execute the translational movement from the current position detected by the current position detection unit to the target position set by the setting unit.

8. The manipulator according to claim 6, further comprising:
a current speed detection unit configured to detect a current speed of the part, wherein
the setting unit further sets a target speed of the part, and
the control unit causes the part to execute the translational movement such that the current speed detected by the current speed detection unit becomes the target speed set by the setting unit.

9. The manipulator according to claim 1, further comprising:
an elastic joint portion around the part.

10. The manipulator according to claim 9, wherein
the joint portion includes a joint state detection unit in which a state of the joint portion is detected, and
the control unit controls the movement of the part further based on the state of the joint portion detected by the joint state detection unit.

11. The manipulator according to claim 10, wherein
the joint state detection unit includes a torque detection unit that detects a torque of the joint portion, and
the control unit controls the movement of the part further based on the torque of the joint portion detected by the torque detection unit.

12. The manipulator according to claim 11, wherein
the control unit further controls passivity of the part based on the torque of the joint portion detected by the torque detection unit.

13. The manipulator according to claim 12, wherein
the setting unit further sets a target torque of the joint portion, and
the control unit controls the passivity of the part based on a difference between the target torque of the joint portion set by the setting unit and the torque of the joint portion detected by the torque detection unit.

14. The manipulator according to claim 7, wherein
the setting unit sets the movement direction in which a hand portion of the manipulator is caused to move and the passive direction in which the hand portion has passivity,
the hand portion includes a contact state detection unit that detects a contact state between the object and a distal end portion of the hand portion at the distal end portion of the hand portion, and
the control unit controls a movement of the hand portion further based on the contact state detected by the contact state detection unit.

15. The manipulator according to claim 14, wherein
the contact state detection unit includes a force sense detection unit that detects a force of the hand portion in at least one of the movement direction and the passive direction, and
the control unit controls the movement of the hand portion further based on the force of the hand portion detected by the force sense detection unit.

16. The manipulator according to claim 15, wherein
the control unit further controls passivity of the hand portion based on the force of the hand portion detected by the force sense detection unit.

17. The manipulator according to claim 16, wherein
the control unit controls the passivity of the hand portion based on a difference between the target position of the distal end portion of the hand portion and the current position of the distal end portion of the hand portion.

18. The manipulator according to claim 17, further comprising:
a learning unit configured to learn a learning model in which the passivity of the hand portion is output in a case where the difference between the target position of the distal end portion of the hand portion and the current position of the distal end portion of the hand portion is input, by using the difference between the target position of the distal end portion of the hand portion and the current position of the distal end portion of the hand portion and the passivity of the hand portion as teacher data, wherein
the control unit controls the passivity of the hand portion by using the learning unit.

19. The manipulator according to claim 1, wherein
the setting unit further sets a task of the manipulator, and sets the movement direction and the passive direction based on the set task.

20. A method for controlling a manipulator executed by a manipulator, the method comprising:
a setting step of setting a movement direction in which at least one part of the manipulator is caused to move and a passive direction in which the part has passivity; and
a control step of controlling a movement of the part based on the movement direction and the passive direction set by the setting step.
